(19) United States
(12) Patent Application Publication
(10) Pub. No.: US 2009/0323494 A1
(43) Pub. Date: Dec. 31, 2009

(54) INFORMATION REPRODUCING APPARATUS AND METHOD, AND COMPUTER PROGRAM

(75) Inventors: Yoshio Sasaki, Saitama (JP); Shogo Miyanabe, Saitama (JP); Hiroyuki Uchino, Saitama (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/446,639

(22) PCT Filed: Oct. 31, 2006
(86) PCT No.: PCT/JP2006/321791

§ 371 Date: Apr. 22, 2009

(51) Int. Cl. G11B 7/00

(52) U.S. Cl. 369/99; G9B/7

(57) ABSTRACT

An information reproducing apparatus (1) is provided with: an amplitude limiting device (151, 152) for obtaining an amplitude limit signal (RS_{LIM}) by limiting an amplitude level of a read signal (R_{RF}) read from a recording medium (100) on the basis of a predetermined amplitude limit value; and a filtering device (158) for obtaining an equalization-corrected signal (RS_{H}) by performing a high-frequency emphasizing and filtering process on the amplitude limit signal, the amplitude limiting device individually sets each of an upper limit (L1) and a lower limit (L2) of the amplitude limit value.

### TECHNICAL FIELD

The present invention relates to an information reproducing apparatus and method which reproduce record data recorded on a recording medium, and in particular, an information reproducing apparatus and method which perform waveform equalization, such as a filtering process, on a read signal obtained by reading the record data recorded on the recording medium, as well as a computer program which makes a computer function as the information reproducing apparatus.

### BACKGROUND ART

In order to improve an SN ratio of a read signal read from the recording medium on which the data is recorded at high density, there is known a technology in which a filtering process for emphasizing high frequencies is performed on the read signal, for waveform equalization. In particular, according to a patent document 1, the technology is disclosed that the high frequencies are emphasized without any intersymbol interference by performing the filtering process after amplitude limit is performed on the read signal (a technology about a so-called limit equalizer).

Patent document 1: Japanese Patent No. 3459563

### DISCLOSURE OF INVENTION

### Subject to be Solved by the Invention

On the limit equalizer, the upper limit and the lower limit of the amplitude limit value are set to a value which is greater than a read signal level obtained by reading record data with the shortest run length (e.g. record data with a run length of 3T in a DVD, and record data with a run length of 2T in a Blu-ray Disc) and which is less than a read signal level obtained by reading record data with the second shortest run length (e.g. record data with a run length of 4T in a DVD, and record data with a run length of 3T in a Blu-ray Disc). Moreover, the upper limit and the lower limit of the amplitude limit value are set to be vertically symmetric with a zero level (or a reference level) being as the base.

However, if the upper limit and the lower limit of the amplitude limit value are set to be vertically symmetric, the upper limit or the lower limit likely increases or reduces excessively, in particular, with respect to the read signal in which asymmetry occurs, depending on a direction in which the asymmetry occurs. This cannot eliminate an influence of intersymbol interference and occurrence of a jitter, so that it is not preferable.

In view of the aforementioned problems, it is therefore an object of the present invention to provide an information reproducing apparatus and method which can perform the waveform equalization while performing the amplitude limit in a better manner, as well as a computer program.

### Means for Solving the Subject

The above object of the present invention can be achieved by an information reproducing apparatus provided with: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, the amplitude limiting device individually setting each of an upper limit and a lower limit of the amplitude limit value.

The above object of the present invention can be also achieved by an information reproducing method provided with: an amplitude limiting process of obtaining an amplitude limit signal by limiting an amplitude level of a read signal read from a recording medium on the basis of a predetermined amplitude limit value; and a filtering process of obtaining an equalization-corrected signal by performing a high-frequency emphasizing and filtering process on the amplitude limit signal, the amplitude limiting process individually setting each of an upper limit and a lower limit of the amplitude limit value.

The above object of the present invention can be also achieved by a computer program for reproduction control and for controlling a computer provided in an information reproducing apparatus provided with: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, the amplitude limiting device individually setting each of an upper limit and a lower limit of the amplitude limit value, the computer program making the computer function as at least one portion of the amplitude limiting device and the filtering device.

The operation and other advantages of the present invention will become more apparent from the embodiments described below

### BRIEF DESCRIPTION OF THE DRAWINGS

FIG. 1 is a block diagram conceptually showing the basic structure of an information reproducing apparatus in a first example.

FIG. 2 is a block diagram conceptually showing the structure of a limit equalizer in the first example.

FIG. 3 is a waveform chart conceptually showing an operation of setting the upper limit and the lower limit of an amplitude limit value, on a sample value series.

FIG. 4 are waveform charts conceptually showing an operation of obtaining a high-frequency emphasized read sample value series, on the sample value series.

FIG. 5 are waveform charts conceptually showing the sample value series and the upper limit and the lower limit of the amplitude limit value if there is asymmetry.

FIG. 6 is a graph conceptually showing a correlation between the asymmetry and a jitter value.

FIG. 7 is a block diagram conceptually showing the basic structure of an information reproducing apparatus in a second example.

FIG. 8 is a block diagram conceptually showing the structure of a limit equalizer in the second example.

FIG. 9 is a waveform chart conceptually showing a value.

FIG. 10 is a block diagram conceptually showing the structure of an offset calculation block for calculating offset values based on the value.

FIG. 11 is a flowchart conceptually showing a flow of one operation of the information reproducing apparatus in the second example when the offset values based on the value are calculated.

FIG. 12 is a flowchart conceptually showing a flow of another operation of the information reproducing apparatus in the example when the offset values based on the value are calculated.

FIG. 13 is a waveform chart conceptually showing another value.

FIG. 14 is a block diagram conceptually showing an offset calculation block for calculating another value.

FIG. 15 is a waveform chart conceptually showing an asymmetry value.

FIG. 16 is a block diagram conceptually showing the structure of an offset calculation block for calculating offset values based on the asymmetry value.

FIG. 17 is a flowchart conceptually showing a flow of one operation of the information reproducing apparatus in the second example when the offset values based on the asymmetry value are calculated.

FIG. 18 is a flowchart conceptually showing a flow of another operation of the information reproducing apparatus in the second example when the offset values based on the asymmetry value are calculated.

FIG. 19 is a waveform chart conceptually showing waveform distortion.

FIG. 20 is a block diagram conceptually showing an offset calculation block for calculating offset values based on a waveform distortion amount.

FIG. 21 is a waveform chart conceptually showing another waveform distortion.

FIG. 22 is a flowchart conceptually showing a flow of one operation of the information reproducing apparatus in the second example when the offset values based on the waveform distortion amount are calculated.

FIG. 23 is a flowchart conceptually showing a flow of another operation of the information reproducing apparatus in the second example when the offset values based on the waveform distortion are calculated.

FIG. 24 are waveform charts conceptually showing an operation of obtaining a highfrequency emphasized read sample value series, in each of a case where the upper limit and the lower limit of the amplitude limit value are set in the method in the background art and a case where the upper limit and the lower limit of the amplitude limit value are set individually.

FIG. 25 is a graph showing a change in symbol error rate with respect to a positional relation between the upper limit or lower limit of the amplitude limit value and the waveform distortion.

FIG. 26 is a block diagram conceptually showing the structure of an offset calculation block for calculating offset values on the basis of the waveform distortion amount in view of that synchronization data is included in record data.

### DESCRIPTION OF REFERENCE CODES

1, 2 information reproducing apparatus
10 spindle motor
11 pickup
12 HPF
13 A/D converter
14 pre-equalizer
15, 25 limit equalizer
16 binary circuit
17 decoding circuit
151 amplitude limit value setting block
1516 averaging circuit
152 amplitude limit block
1522 interpolation filter
1523 upper limiter
1524 lower limiter
153 high-frequency emphasis block
154 offset calculation block
L1 upper limit of amplitude limit value
L2 lower limit of amplitude limit value

### BEST MODE FOR CARRYING OUT THE INVENTION

Hereinafter, as the best mode for carrying out the present invention, an explanation will be given on embodiments of the information reproducing apparatus and method, and the computer program of the present invention.

### Embodiment of Information Reproducing Apparatus

An embodiment of the information reproducing apparatus of the present invention is an information reproducing apparatus provided with: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, the amplitude limiting device individually setting each of an upper limit and a lower limit of the amplitude limit value.

According to the embodiment of the information reproducing apparatus of the present invention, the amplitude level of the read signal read from the recording medium is limited by the operation of the amplitude limiting device. Specifically, with respect to a signal component of the read signal in which the amplitude level is greater than or equal to the upper limit of the amplitude limit value or is less than or equal to the lower limit of the amplitude limit value, the amplitude level is limited to the upper limit or the lower limit of the amplitude limit value. On the other hand, with respect to a signal component of the read signal in which the amplitude level is less than or equal to the upper limit of the amplitude limit value or is greater than or equal to the lower limit of the amplitude limit value, the amplitude level is not limited. The read signal in which the amplitude level is limited as described above is outputted to the filtering device as the amplitude limit signal. On the filtering device, the high-frequency emphasis filtering process is performed on the amplitude limit signal. As a result, the equalization-corrected signal is obtained. Then, for example, a binary process, a decoding process, and the like are performed on the equalization-corrected signal. By this, it is possible to perform a reproduction process on record data (e.g. video data, audio data, and the like) recorded on the recording medium.

This can limit or control the dispersion (i.e. jitter) of the read signal (or its sample values) on the filtering device, resulting in the high-frequency emphasis on the read signal without intersymbol interference.

In the embodiment, in particular, the amplitude limiting device can set each of the upper limit and the lower limit of the amplitude limit value, individually (in other words, separately and independently). As a result, in the embodiment, the upper limit and the lower limit of the amplitude limit value sometimes cannot be in the relation that they are located symmetrically to a reference level (e.g. zero level). In other words, the absolute value of the upper limit of the amplitude limit value sometimes can be different from that of the lower limit of the amplitude limit value.

Thus, even if asymmetry or the like occurs in the read signal, it is possible to individually set each of the upper limit and the lower limit of the amplitude limit value, in view of an influence due to the asymmetry or the like. Thus, it is possible to preferably prevent such a disadvantage that the upper limit or the lower limit of the amplitude limit value excessively increases or reduces with respect to the amplitude level of the read signal, which is caused by the occurrence of the asymmetry or the like. Thus, it is possible to perform the high-frequency emphasis on the read signal without intersymbol interference.

As described above, according to the information reproducing apparatus in the embodiment, it is possible to perform waveform equalization while performing amplitude limit in a better manner.

In one aspect of the embodiment of the information reproducing apparatus of the present invention, the upper limit of the amplitude limit value is an average value of sample values which are before or after a reference sample point of the read signal and which have a value greater than or equal to a reference level.

According to this aspect, it is possible to preferably set the upper limit of the amplitude limit value.

Incidentally, the “reference sample point” in the embodiment denotes a point at which the signal level of the read signal is equal to the reference level. If the reference level is a zero level, the reference sample point corresponds to a zero cross point.

Moreover, the “sample values” in the embodiment denote not only sample values obtained by sampling the read signal at a sampling frequency normally used, but also interpolated sample values obtained by performing an interpolation process on the sample values. In short, the sample values obtained in discrete dispersion from the read signal as an analog signal on a time axis (i.e. obtained in a digital manner) correspond to the “sample values” in the embodiment.

In another aspect of the embodiment of the information reproducing apparatus of the present invention, the lower limit of the amplitude limit value is an average value of sample values which are before or after a reference sample point of the read signal and which have a value less than or equal to a reference level.

According to this aspect, it is possible to preferably set the lower limit of the amplitude limit value.

In another aspect of the embodiment of the information reproducing apparatus of the present invention, the upper limit of the amplitude limit value is greater than a signal level of a read signal obtained by reading record data with the shortest run length (e.g. record data with a run length of 3T if the recording medium is a DVD, and record data with a run length of 2T if the recording medium is a Blu-ray Disc) of the read signal, and the upper limit of the amplitude limit value is less than a signal level of a read signal obtained by reading the record data with the second shortest run length (e.g. record data with a run length of 4T if the recording medium is a DVD, and record data with a run length of 3T if the recording medium is a Blu-ray Disc) of the read signal

According to this aspect, it is possible to preferably set the upper limit of the amplitude limit value.

In another aspect of the embodiment of the information reproducing apparatus of the present invention, the lower limit of the amplitude limit value is less than a signal level of a read signal obtained by reading record data with the shortest run length of the read signal, and the lower limit of the amplitude limit value is greater than a signal level of a read signal obtained by reading the record data with the second shortest run length of the read signal

According to this aspect, it is possible to preferably set the lower limit of the amplitude limit value.

In another aspect of the embodiment of the information reproducing apparatus of the present invention, at least one of the upper limit and the lower limit of the amplitude limit value is set in accordance with at least one of (i) an asymmetry value which indicates a shift amount of an amplitude center of a read signal obtained by reading record data with the shortest run length of the read signal, with respect to a maximum amplitude of a read signal obtained by reading the record data with the longest run length of the read signal; (ii) an entire value which indicates an average value of the amplitude center of the read signal; and (iii) a partial value which indicates deviation of the amplitude center of the read signal obtained by reading the record data with the shortest run length of the read signal and the amplitude center of the read signal obtained by reading the record data with the second shortest run length of the read signal.

According to this aspect, it is possible to set the upper limit and the lower limit of the amplitude limit value, in view of an influence due to an amplitude shift, an amplitude center shift, or the like of each read signal obtained by reading each record data with a different run length. In other words, it is possible to set the optimum upper limit and the optimum lower limit of the amplitude limit value in accordance with the asymmetry value and the value (specifically, the entire value and the partial value) which actually occur.

In an aspect of the information reproducing apparatus in which at least one of the upper limit and the lower limit of the amplitude limit value is set in accordance with at least one of the asymmetry value, the entire value, and the partial value, as described above, the upper limit of the amplitude limit value may be set by adding an offset value which is set in accordance with at least one of the asymmetry value, the entire value, and the partial value, to an average value of sample values which are before or after a reference sample point of the read signal and which have a value greater than or equal to a reference level.

By virtue of such construction, it is possible to set the upper limit of the amplitude limit value by adding the offset value which is set in view of the asymmetry value, the entire value, and the partial value which actually occur. In other words, it is possible to relative easily set the optimum upper limit of the amplitude limit value in accordance with the asymmetry value, the entire value, and the partial value.

In an aspect of the information reproducing apparatus in which at least one of the upper limit and the lower limit of the amplitude limit value is set in accordance with at least one of the asymmetry value, the entire value, and the partial value, as described above, the lower limit of the amplitude limit value may be set by adding an offset value which is set in accordance with at least one of the asymmetry value, the entire value, and the partial value, to an average value of sample values which are before or after a reference sample point of the read signal and which have a value less than or equal to a reference level.

By virtue of such construction, it is possible to set the lower limit of the amplitude limit value by adding the offset value which is set in view of the asymmetry value, the entire value, and the partial value which actually occur. In other words, it is possible to relative easily set the optimum lower limit of the amplitude limit value in accordance with the asymmetry value, the entire value, and the partial value.

In an aspect of the information reproducing apparatus in which at least one of the upper limit and the lower limit of the amplitude limit value is set in accordance with at least one of the asymmetry value, the entire value, and the partial value, as described above, out of an average value of sample values which are before or after a reference sample point of the read signal and which have a value greater than or equal to a reference level and an average value of sample values which are before or after the reference sample point of the read signal and which have a value less than or equal to the reference level, a value having a smaller absolute value may be set as one of the upper limit and the lower limit of the amplitude limit value, and a value which is obtained by adding the doubled partial value to the value having the smaller absolute value out of the two average values (i.e. the average value of sample values which are before or after the reference sample point of the read signal and which have a value greater than or equal to the reference level and the average value of sample values which are before or after the reference sample point of the read signal and which have a value less than or equal to the reference level) may be set as the other of the upper limit and the lower limit of the amplitude limit value.

By virtue of such construction, it is possible to set the upper limit and the lower limit of the amplitude limit value in view of the partial value In other words, it is possible to set the optimum upper limit and the optimum lower limit of the amplitude limit value in accordance with the partial value.

In an aspect of the information reproducing apparatus in which at least one of the upper limit and the lower limit of the amplitude limit value is set in accordance with at least one of the asymmetry value, the entire value, and the partial value, as described above, at least one of the upper limit and the lower limit of the amplitude limit value may be set such that a sum of the upper limit and the lower limit of the amplitude limit value is equal to a sum of the upper limit and the lower limit of the amplitude limit value in the case where the entire value is zero.

By virtue of such construction, it is possible to individually set the upper limit and the lower limit of the amplitude limit value in view of the relation between the upper limit and the lower limit in the case where the entire value is zero (i.e. when an average value of the amplitude center of the read signal is a zero level).

In another aspect of the embodiment of the information reproducing apparatus of the present invention, at least one of the upper limit and the lower limit of the amplitude limit value is set in accordance with a waveform distortion amount which is amount of waveform distortion of the read signal.

According to this aspect, it is possible to set the upper limit and the lower limit of the amplitude limit value in view of an influence due to the waveform distortion. In other words, it is possible to set the optimum upper limit and the optimum lower limit of the amplitude limit value in accordance with the waveform distortion amount which actually occurs.

Incidentally, the waveform distortion easily occurs in the read signal obtained by reproducing record data of a long pattern (e.g. record data with a run length of 11T if the recording medium is a DVD, and record data with a run length of 8T if the recording medium is a Blu-ray Disc).

In an aspect of the information reproducing apparatus in which at least one of the upper limit and the lower limit is set in accordance with the waveform distortion amount, as described above, the upper limit of the amplitude limit value may be set by adding an offset value which is set in accordance with the waveform distortion amount, to an average value of sample values which are before or after a reference sample point of the read signal and which have a value greater than or equal to a reference level.

By virtue of such construction, it is possible to set the upper limit of the amplitude limit value by adding the offset value which is set in view of the waveform distortion which actually occurs. In other words, it is possible to relatively easily set the optimum upper limit of the amplitude limit value in accordance with the waveform distortion amount.

In an aspect of the information reproducing apparatus in which at least one of the upper limit and the lower limit is set in accordance with the waveform distortion amount, as described above, the lower limit of the amplitude limit value may be set by adding an offset value which is set in accordance with the waveform distortion amount, to an average value of sample values which are before or after a reference sample point of the read signal and which have a value less than or equal to a reference level.

By virtue of such construction, it is possible to set the lower limit of the amplitude limit value by adding the offset value which is set in view of the waveform distortion which actually occurs. In other words, it is possible to relatively easily set the optimum lower limit of the amplitude limit value in accordance with the waveform distortion amount.

In an aspect of the information reproducing apparatus in which at least one of the upper limit and the lower limit is set in accordance with the waveform distortion amount, as described above, at least one of the upper limit and the lower limit of the amplitude limit value may be set such that each of the upper limit and the lower limit of the amplitude limit value does not cross the waveform distortion.

By virtue of such construction, it is possible to perform the high-frequency emphasis while eliminating the influence due to the waveform distortion.

In an aspect of the information reproducing apparatus in which at least one of the upper limit and the lower limit is set in accordance with the waveform distortion amount, as described above, the amplitude limiting device may set at least one of the upper limit and the lower limit of the amplitude limit value in limiting the amplitude level of the read signal corresponding to user data out of record data, in accordance with the waveform distortion amount of the read signal corresponding to the user data, and the amplitude limiting device may set at least one of the upper limit and the lower limit of the amplitude limit value in limiting the amplitude level of the read signal corresponding to synchronization data out of record data, in accordance with the waveform distortion amount of the read signal corresponding to the synchronization data, the synchronization data being for synchronization in reproducing the user data.

By virtue of such construction, it is possible to eliminate the influence due to the waveform distortion, with respect to the read signal corresponding to the synchronization data which is important when the record data is reproduced.

Incidentally, the amplitude limiting device may set at least one of the upper limit and the lower limit of the amplitude limit value in limiting the amplitude level of each of the read signal corresponding to the user data and the read signal corresponding to the synchronization data, in accordance with the waveform distortion amount of the read signal corresponding to the synchronization data.

### Embodiment of Information Reproducing Method

An embodiment of the information reproducing method of the present invention is an information reproducing method provided with: an amplitude limiting process of obtaining an amplitude limit signal by limiting an amplitude level of a read signal read from a recording medium on the basis of a predetermined amplitude limit value; and a filtering process of obtaining an equalization-corrected signal by performing a high-frequency emphasizing and filtering process on the amplitude limit signal, the amplitude limiting process individually setting each of an upper limit and a lower limit of the amplitude limit value.

According to the embodiment of the information reproducing method of the present invention, it is possible to receive the same various effects as those that can be received by the aforementioned embodiment of the information reproducing apparatus of the present invention.

Incidentally, in response to the various aspects in the aforementioned embodiment of the information reproducing apparatus of the present invention, the embodiment of the information reproducing method of the present invention can also adopt various aspects.

### Embodiment of Computer Program

An embodiment of the computer program of the present invention is a computer program for reproduction control and for controlling a computer provided in an information reproducing apparatus provided with: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, the amplitude limiting device individually setting each of an upper limit and a lower limit of the amplitude limit value (i.e. the aforementioned embodiment of the information reproducing apparatus of the present invention (including its various aspects)), the computer program making the computer function as at least one portion of the amplitude limiting device and the filtering device.

According to the embodiment of the computer program of the present invention, the aforementioned embodiment of the information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the information reproducing apparatus of the present invention, the embodiment of the computer program of the present invention can also employ various aspects.

An embodiment of the computer program product of the present invention is a computer program product in a computer-readable medium for tangibly embodying a program of instructions executable by a computer provided in an information reproducing apparatus provided with: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, the amplitude limiting device individually setting each of an upper limit and a lower limit of the amplitude limit value (i.e. the aforementioned embodiment of the information reproducing apparatus of the present invention (including its various aspects)), the computer program making the computer function as at least one portion of the amplitude limiting device and the filtering device.

According to the embodiment of the computer program product of the present invention, the aforementioned embodiment of the information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information reproducing apparatus of the present invention.

Incidentally, in response to the various aspects in the aforementioned embodiment of the information reproducing apparatus of the present invention, the embodiment of the computer program product of the present invention can also employ various aspects.

The operation and other advantages of the present invention will become more apparent from the examples explained below.

As explained above, according to the embodiment of the information reproducing apparatus of the present invention, it is provided with the amplitude limiting device and the filtering device, and the amplitude limiting device individually sets each of the upper limit and the lower limit of the amplitude limit value. According to the embodiment of the information reproducing method of the present invention, it is provided with the amplitude limiting process and the filtering process, and the amplitude limiting process individually sets each of the upper limit and the lower limit of the amplitude limit value. According to the embodiment of the computer program of the present invention, it makes a computer function as the embodiment of the information reproducing apparatus of the present invention. Therefore, it is possible to perform waveform equalization while performing amplitude limit in a better manner.

### EXAMPLES

Hereinafter, examples of the present invention will be described on the basis of the drawings.

### (1) First Example

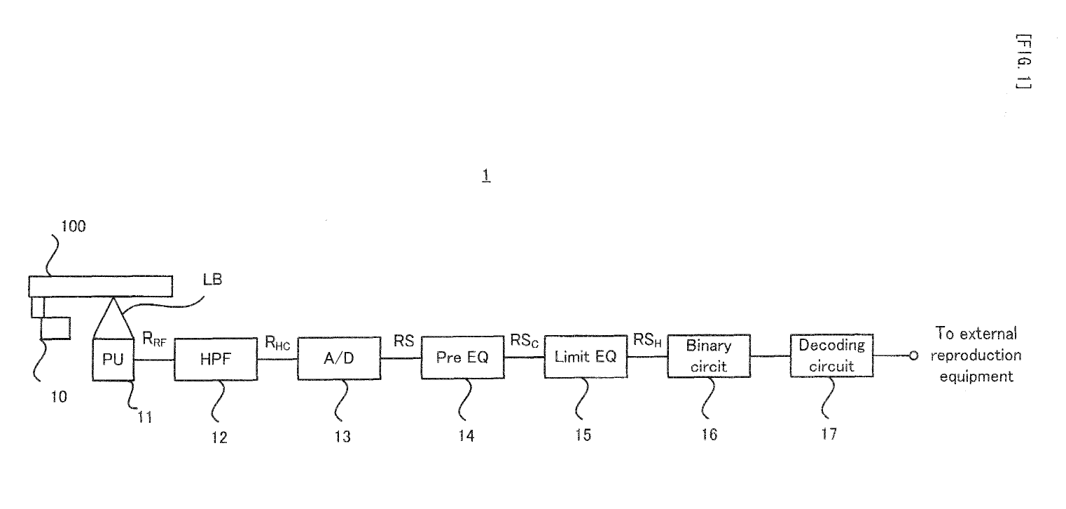

Firstly, with reference to FIG 1, a first example of the information reproducing apparatus of the present invention will be described. FIG. 1 is a block diagram conceptually showing the basic structure of the information reproducing apparatus in the first example.

As shown in FIG. 1, an information reproducing apparatus 1 in the first example is provided with a spindle motor 10, a pickup (PU) 11, a HPF (High Pass Filter) 12, an A/D converter 13, a pre-equalizer 14, a limit equalizer 15, a binary circuit 16, and a decoding circuit 17.

The pickup 11 photoelectrically converts reflected light when a laser beam LB is applied to a recording surface of an optical disc 100 rotated by the spindle motor 10, to thereby generate a read signal R_{RF}.

The HPF 12 removes a low-frequency component of the read signal R_{RF} outputted from the pickup, and it outputs a resulting read signal R_{HC} to the A/D converter 13.

The A/D converter 13 samples the read signal in accordance with a sampling clock outputted from a PLL (Phased Lock Loop) not illustrated or the like, and it outputs a resulting read sample value series RS to the pre-equalizer 14.

The pre-equalizer 14 removes intersymbol interference based on transmission characteristics in an information reading system, which is formed of the pickup 11 and the optical disc 100, and it outputs a resulting read sample value series RS_{C} to the limit equalizer 15.

The limit equalizer 15 performs a high-frequency emphasis process on the read sample value series RS_{C} without increasing the intersymbol interference, and it outputs a resulting high-frequency emphasized read sample value series RS_{H} to the binary circuit 16.

The binary circuit 16 performs a binary process on the high-frequency emphasized read sample value series RS_{H}, and it outputs a resulting a binary signal to the decoding circuit 17.

The decoding circuit 17 performs a decoding process or the like on the binary signal, and it outputs a resulting reproduction signal to external reproduction equipment, such as a display and a speaker. As a result, record data recorded on the optical disc 100 (e.g. video data, audio data, and the like) is reproduced.

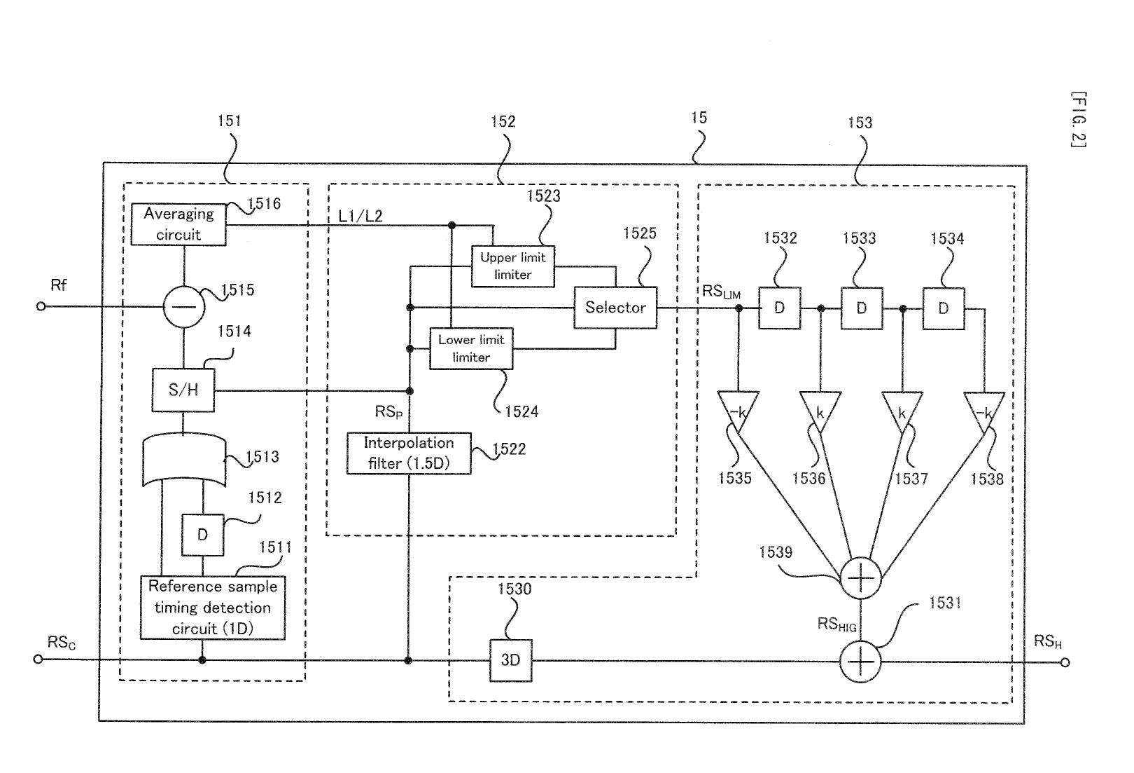

Next, with reference to FIG. 2, the detailed structure of the limit equalizer 15 will be described. FIG. 2 is a block diagram conceptually showing the structure of the limit equalizer 15 in the first example.

As shown in FIG. 2, the limit equalizer 15 is provided with an amplitude limit value setting block 151, which constitutes one specific example of the “amplitude limiting device” of the present invention; an amplitude limit block 152, which constitutes one specific example of the “amplitude limiting device” of the present invention; and a high-frequency emphasis block 153, which constitutes one specific example of the “filtering device” of the present invention.

The amplitude limit value setting block 151 sets the upper limit L1 and the lower limit L2 of an amplitude limit value used on the amplitude limit block 152, on the basis of the read sample value series RS_{C}. The amplitude limit block 152 performs an amplitude limit process on the read sample value series RS_{C}, on the basis of the upper limit L1 and the lower limit L2 of the amplitude limit value set on the amplitude limit value setting block 151. A sample value series RS_{LIM}, to which the amplitude limit process is performed is outputted to the high-frequency emphasis block 153. The high-frequency emphasis block 153 performs a filtering process for emphasizing high frequencies, on the sample value series RS_{LIM} to which the amplitude limit process is performed. As a result, the high-frequency emphasized read sample value series RS_{H} is obtained.

More specifically, a reference sample timing detection circuit 1511 detects reference sample timing, on the basis of the read sample value series RS_{C}. The detected reference sample timing is outputted to a sample hold circuit 1514 through a delayer 1512 for providing a one-clock delay and an OR circuit 1513. On the sample hold circuit 1514, a sample value series RS_{P} outputted from an interpolation filter 1522 is sampled and held in accordance with the reference sample timing outputted through the delayer 1512 and the OR circuit 1513.

Incidentally, the interpolation filter 1522 performs an interpolation process on the read sample value series RS_{C}, to thereby generate an interpolated sample value series which is obtained when the read signal R_{RF} read from the optical disc 100 is sampled in the middle timing of the clock timing by the sampling clock used on the A/D converter 14. The generated interpolated sample value series is included in the read sample value series RS_{C}, and it is outputted to an upper limiter 1523, a lower limiter 1524, a selector 1525, and the sample hold circuit 1514, as the sample value series RS_{P}.

From the read sample value series RS_{P} sampled and held, a reference level Rf is subtracted on a subtractor 1515. The subtraction result is outputted to an averaging circuit 1516. The averaging circuit 1516 calculates an average value of sample values. The calculated average value of sample values is set as the upper limit L1 and the lower limit L2 of the amplitude limit value.

At this time, the averaging circuit 1516 sets the upper limit L1 and the lower limit L2, separately and independently (in other words, individually). In other words, the averaging circuit 1516 separately and independently calculates an average value of values which are at the reference level or more and an average value of values which are at the reference level or less, among the sample value series RS_{P} sampled and held.

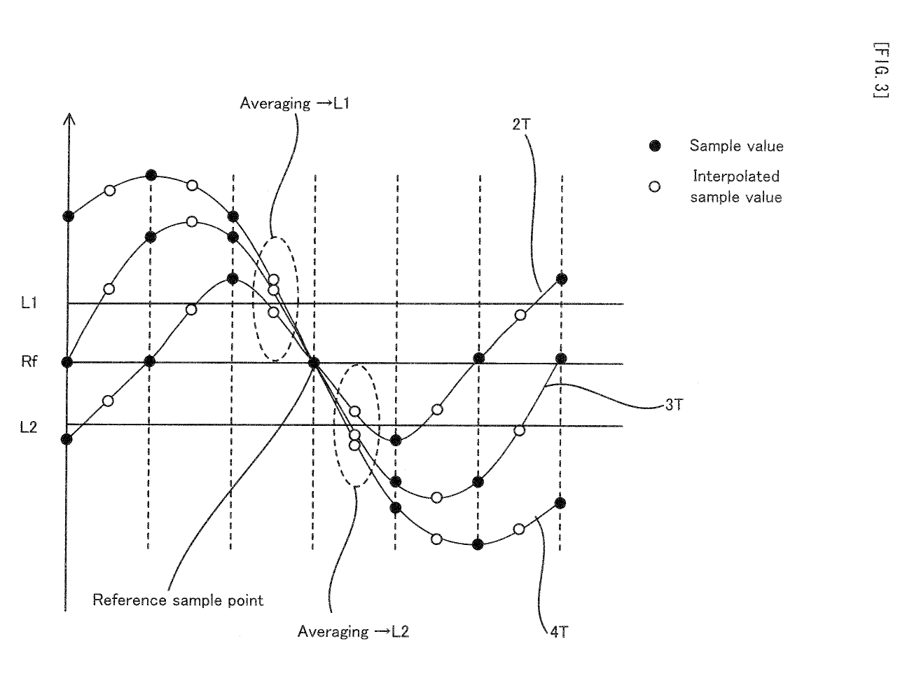

Specifically, with reference to FIG. 3, an explanation will be given on the upper limit L1 and the lower limit L2 of the amplitude limit value set on the amplitude limit value setting block 151. FIG. 3 is a waveform chart conceptually showing an operation of setting the upper limit L1 and the lower limit L2 of the amplitude limit value on the sample value series RS_{C}.

FIG. 3 shows the read signal R_{RF} obtained in reading record data with a relatively short run length (specifically, record data with run lengths of 2T, 3T, and 4T if the optical disc 100 is a Blu-ray Disc) of the read signal; and its sample value series RS_{C}. As shown in FIG. 3, an average value of interpolated sample values (sample values generated on the interpolation filter 1522) located before (i.e. before in terms of time) a reference sample point is set as the upper limit L1 of the amplitude limit value. An average value of interpolated sample values located after (i.e. after in terms of time) a reference sample point is set as the lower limit L2 of the amplitude limit value. In other words, an average value of interpolated sample values which are located before or after the reference sample point and which are at the reference level or more is set as the upper limit L1 of the amplitude limit value. In the same manner, an average value of interpolated sample values which are located before or after the reference sample point and which are at the reference level or less is set as the lower limit L2 of the amplitude limit value.

Incidentally, in the example shown in FIG. 3, the interpolated sample values located before the reference sample point are at the reference level Rf or more, so that the average value of the interpolated sample values located before (before in terms of time) the reference sample point is set as the upper limit L1 of the amplitude limit value. On the other hand, if the interpolated sample values located before the reference sample point are at the reference level Rf or less, the average value of the interpolated sample values located before the reference sample point is set as the lower limit L2 of the amplitude limit value.

In the same manner, in the example shown in FIG. 3, the interpolated sample values located after the reference sample point are at the reference level Rf or less, so that the average value of the interpolated sample values located after the reference sample point is set as the lower limit L2 of the amplitude limit value. On the other hand, if the interpolated sample values located after the reference sample point are at the reference level Rf or more, the average value of the interpolated sample values located after the reference sample point is set as the upper limit L1 of the amplitude limit value.

As described above, in the first example, the upper limit L1 and the lower limit L2 of the amplitude limit value are set, separately and independently. In other words, in the example, without calculating an average value of the absolute values of the interpolated values located each of before and after the reference sample point, the average value of the interpolated sample values located before the reference sample point and the average value of the interpolated sample values located after the reference sample point are individually calculated

Incidentally, in the example shown in FIG. 3, if the reference level coincides with a zero level, the reference sample point coincides with a zero cross point.

In FIG. 2 again, the upper limiter 1523 performs amplitude limit on the sample value series RS_{P} on the basis of the upper limit L1 set on the amplitude limit value setting block 151. Specifically, if a sample value included in the sample value series RS_{P} is less than the upper limit L1, the sample value is outputted as the sample value series RS_{LIM} as it is. On the one hand, if a sample value included in the sample value series RS_{P} is greater than or equal to the upper limit L1, the upper limit L1 is outputted as the sample value series RS_{LIM}.

In the same manner, the lower limiter 1524 performs amplitude limit on the sample value series RS_{P} on the basis of the lower limit L2 set on the amplitude limit value setting block 151. Specifically, if a sample value included in the sample value series RS_{P} is greater than the lower limit L2, the sample value is outputted as the sample value series RS_{LIM} as it is. On the one hand, if a sample value included in the sample value series RS_{P} is less than or equal to the lower limit L2, the lower limit L2 is outputted as the sample value series RS_{LIM}.

The selector 1525 changes the output of each of the upper limiter 1523 and the lower limiter 1524, as occasion demands, and outputs the sample value series RS_{LIM} to the high-frequency emphasis block 153. Specifically, if a sample value included in the sample value series RS_{LIM} is greater than the reference level Rf, the selector 1525 outputs the output from the upper limiter 1523 to the high-frequency emphasis block 153, as the sample value series RS_{LIM}. In the same manner, if a sample value included in the sample value series RS_{LIM} is less than the reference level Rf, the selector 1525 outputs the output from the lower limiter 1524 to the high-frequency emphasis block 153, as the sample value series RS_{LIM}.

At this time, if the sample value included in the sample value series RS_{LIM} is expressed by 2'sComp form, a code bit of the sample value may be referred to, instead of comparing the sample value with the reference level Rf. If the code bit of the sample value shows plus (+), the selector 1525 outputs the output from the upper limiter 1523 to the high-frequency emphasis block 153 as the sample value series RS_{LIM}. In the same manner, if the code bit of the sample value shows minus (−), the selector 1525 outputs the output from the lower limiter 1524 to the high-frequency emphasis block 153 as the sample value series RS_{LIM}.

The high-frequency emphasis block 153 increases the signal level of only the sample value series RS_{LIM} corresponding to the record data with the shortest run length (e.g. the record data with a run length of 3T if the optical disc 100 is a DVD, and the record data with a run length of 2T if the optical disc 100 is a Blu-ray Disc) in the sample value series RS_{LIM}.

Specifically, the sample value series RS_{LIM} inputted to the high-frequency emphasis block 153 is inputted to coefficient multipliers 1535 and 1538 having a multiplier coefficient of −k and coefficient multipliers 1536 and 1537 having a multiplier coefficient of k, as it is or through delayers 1532, 1533, and 1534 for providing a one-clock delay. The outputs of the coefficient multipliers 1535, 1536, 1537, and 1538 are added on an adder 1539. A high-frequency read sample value series RS_{HIG} which is an addition result is added to the read sample value series RS_{C} which is inputted to the adder 1531 through the delayer 1530 for providing a three-clock delay, on the adder 1531. As a result, the high-frequency emphasized read sample value series RS_{H} is obtained.

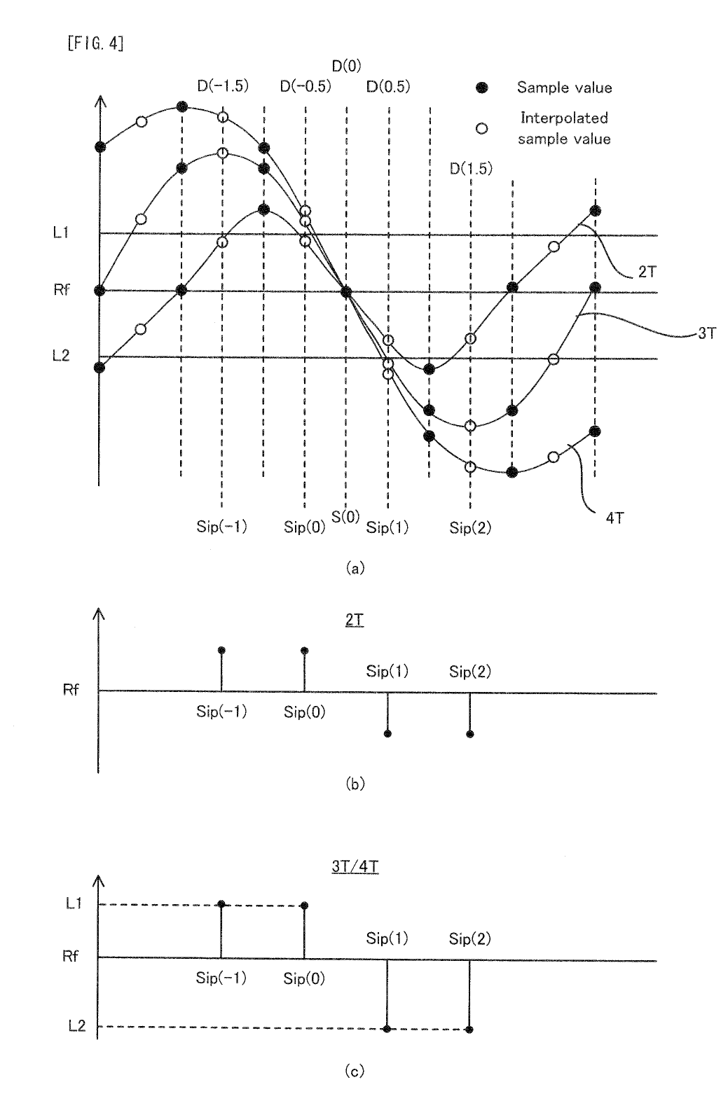

Now, with reference to FIGS. 4, an operation of obtaining the high-frequency emphasized read sample value series RS_{H} will be described in more detail. FIGS. 4 are waveform charts conceptually showing the operation of obtaining the high-frequency emphasized read sample value series RS_{H}, on the sample value series RS_{C}.

As shown in FIG. 4(a), the high-frequency read sample value series RS_{HIG} outputted from the adder 1531 is calculated on the basis of the sample values at respective time points D (−1.5), D(−0.5), D(0.5), and D(1.5) in the sample value series RS_{LIM}. Specifically, if the sample values at the respective time points D (−1.5), D(−0.5), D(0.5), and D(1.5) in the sample value series RS_{LIM} are set to Sip(−1), Sip(0), Sip(1), and Sip(2), then, RS_{HIG}=(−k)×Sip(−1)+k×Sip(0)+k×Sip(1)+(−k)×Sip(2).

At this time, as shown in FIG. 4(b), the sample values Sip(−1) and Sip(0) at the time points D(−1.5) and D(−0.5) corresponding to the data with a run length of 2T are substantially equal to each other. Moreover, the sample values Sip(1) and Sip(2) at the time points D(0.5) and D(1.5) corresponding to the data with a run length of 2T are substantially equal to each other.

Moreover, as shown in FIG. 4(c), the sample values Sip(−1) and Sip(0) at the time points D(−1.5) and D(−0.5) corresponding to the data with each of run lengths of 3T and 4T are both the upper limit L1 of the amplitude limit value, due to the amplitude limit by the amplitude limit block 152. In the same manner, the sample values Sip(1) and Sip(2) at the time points D(0.5) and D(1.5) corresponding to the data with each of run lengths of 3T and 4T are both the lower limit L2 of the amplitude limit value, due to the amplitude limit by the amplitude limit block 152. In other words, the dispersion of the sample values before and after the reference sample point is forcibly controlled.

Thus, even if the value of the coefficient k is increased on the coefficient multipliers 1535, 1536, 1537, and 1538 in order to increase the high-frequency emphasis, the high-frequency read sample value series RS_{HIG} obtained at the zero cross point D(0) is kept constant. Therefore, the intersymbol interference does not occur.

As explained above, according to the information reproducing apparatus 1 in the first example, the dispersion of the sample values before and after the reference sample point in the read signal, which causes the intersymbol interference, is forcibly controlled in the high-frequency emphasis. Thus, even if the sufficient high-frequency emphasis is performed on the high-frequency emphasis block 153, the intersymbol interference does not occur.

In particular, according to the information reproducing apparatus 1 in the first example, it is possible to individually set each of the upper limit L1 and the lower limit L2 of the amplitude limit value. Thus, even if there is asymmetry in the read signal R_{RF}, it is possible to individually set each of the upper limit L1 and the lower limit L2 of the amplitude limit value in view of an influence due to the asymmetry. By this, it is possible to preferably prevent such a disadvantage that the upper limit L1 or the lower limit L2 of the amplitude limit value excessively increases or reduces with respect to the amplitude level of the read signal R_{RF}, which is caused by the occurrence of the asymmetry. Thus, it is possible to eliminate the possibility of the disadvantage and to preferably perform the high-frequency emphasis of the read signal R_{RF}. Of course, the same effect can be received even in the case where a value is not zero, even in the case where there is waveform distortion, or in similar cases.

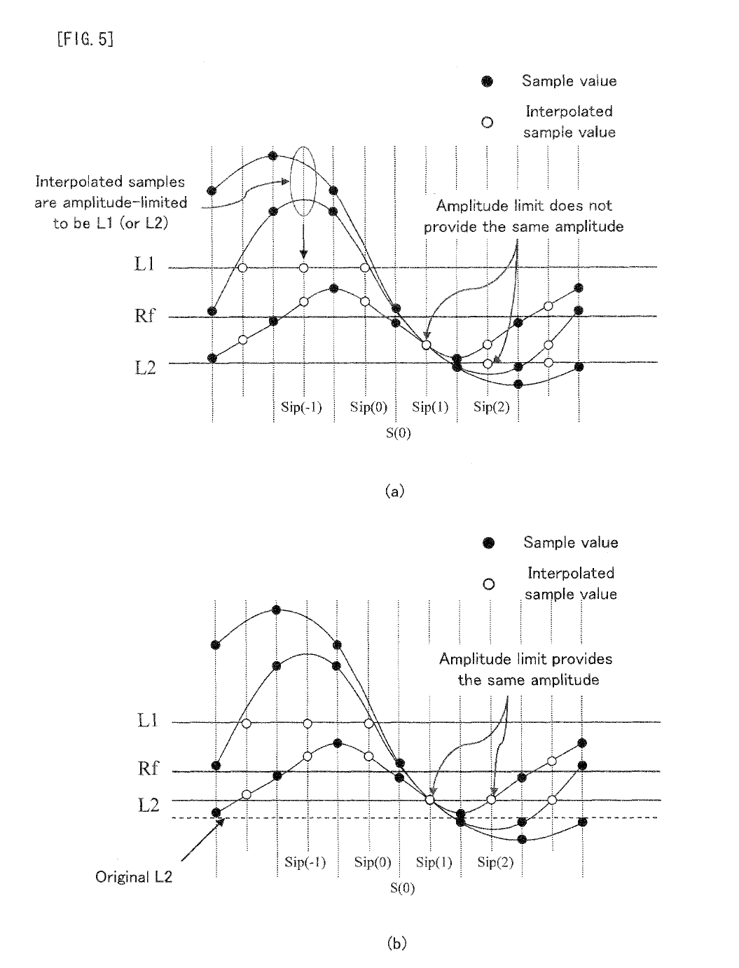

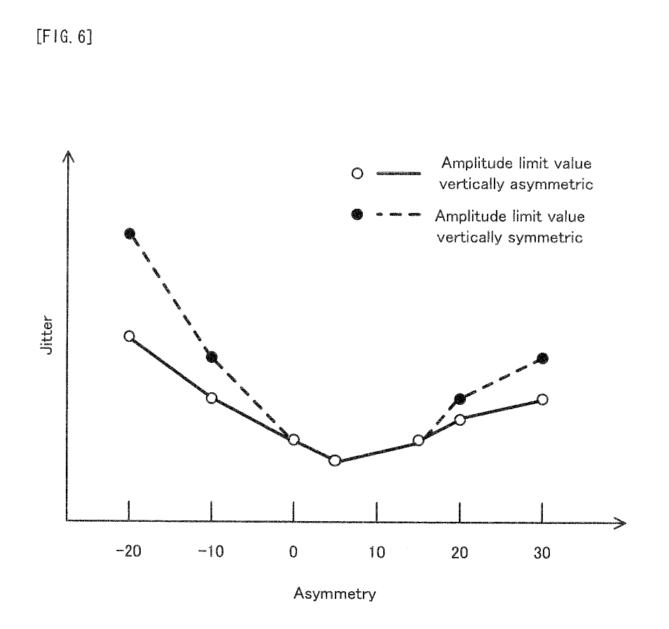

This effect will be described in more detail, with reference to FIGS. 5 and FIG. 6. FIGS. 5 are waveform charts conceptually showing the sample value series RS_{C} and the upper limit L1 and the lower limit L2 of the amplitude limit value if there is asymmetry. FIG. 6 is a graph conceptually showing a correlation between the asymmetry and a jitter value.

As shown in FIG. 5(a), it is assumed that the asymmetry occurs in the read signal R_{RF}. Here, as shown in FIG. 5(a), it is assumed that the upper limit L1 and the lower limit L2 of the amplitude limit value are set to be vertically symmetric with the reference level (or zero level) being as the base (i.e. set in the aforementioned method disclosed in the background art). In this case, the sample values on the upper limit L1 side of the amplitude limit value are relatively large, which increase the absolute value of the lower limit L2 of the amplitude limit value. Thus, the sample value Sip(1) at the time point D(0.5) is not subjected to the amplitude limit. In that case, the sample value Sip(1) at the time point D(0.5) and the sample value Sip(2) at the time point D(1.5) do not have the same value, which results in the intersymbol interference.

On the other hand, as in the first example, if the upper limit L1 and the lower limit L2 of the amplitude limit value are individually set, even if the sample values on the upper limit L1 side of the amplitude limit value are relatively large, the lower limit L2 of the amplitude limit value is set by the sample values on the lower limit L2 side of the amplitude limit value, which does not cause such a disadvantage that the absolute value of the lower limit L2 of the amplitude limit value are increased. Thus, as shown in FIG. 5(b), each of the sample value Sip(1) at the time point D(0.5) and the sample value Sip(2) at the time point D(1.5) is subjected to the amplitude limit, and each of the sample values Sip(1) and Sip(2) becomes the lower limit L2. Thus, the sample value Sip(1) at the time point D(0.5) and the sample value Sip(2) at the time point D(1.5) are equal to each other, and as a result, the intersymbol interference does not occur.

The effect of the information reproducing apparatus 1 in the first example can be also seen from a jitter value. As shown in FIG. 6, it can be seen the jitter is improved if the upper limit L1 and the lower limit L2 of the amplitude limit value are individually set (i.e. the upper limit L1 and the lower limit L2 of the amplitude limit value are set to be vertically asymmetric with the reference level (or zero level) being a base), compared to a case where the upper limit L1 and the lower limit L2 of the amplitude limit value are set to be vertically symmetric with the reference level (or zero level) being a base. This indicates that the intersymbol interference does not occur or hardly occurs.

As described above, according to the information reproducing apparatus 1 in the first example, it is possible to more preferably perform the high-frequency emphasis, compared to the technology disclosed in the aforementioned background art (i.e. the technology that the upper limit L1 and the lower limit L2 of the amplitude limit value are set to be vertically symmetric with the reference level (or zero level) being a base).

### (2) Second Example

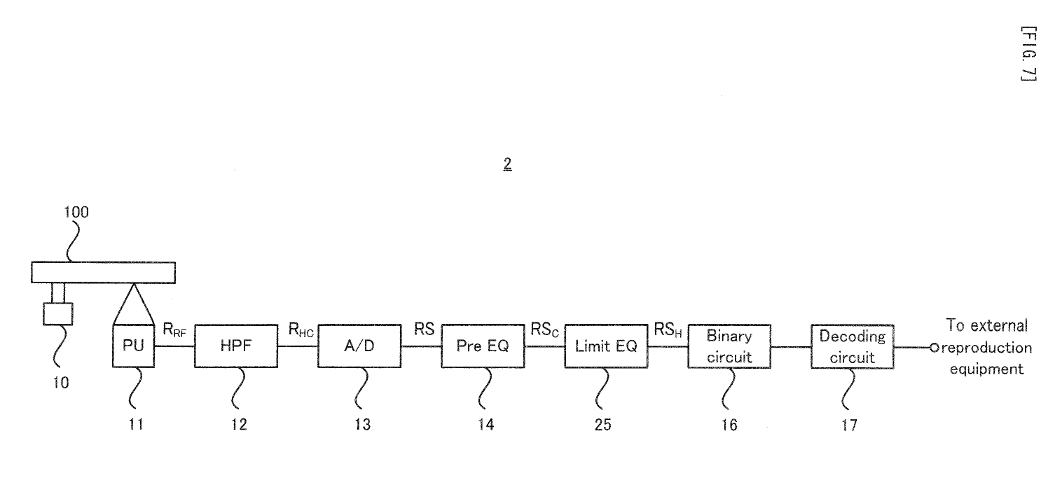

Next, with reference to FIG. 7 to FIG. 26, a second example of the information reproducing apparatus of the present invention will be described.

(2-1) Basic Structure

Firstly, with reference to FIG. 7, the basic structure of the second example of the information reproducing apparatus of the present invention will be described. FIG. 7 is a block diagram conceptually showing the basic structure of the information reproducing apparatus in the second example. Incidentally, the same constituents of the information reproducing apparatus 1 in the first example carry the same reference numerals, and their detailed explanation are omitted.

As shown in FIG. 7, an information reproducing apparatus 2 in the second example is provided with the spindle motor 10, the pickup (PU) 11, the HPF (High Pass Filter) 12, the A/D converter 13, the pre-equalizer 14, a limit equalizer 25, the binary circuit 16, and the decoding circuit 17.

In other words, in the information reproducing apparatus 2 in the second example, the structure of the limit equalizer 25 is different, compared to the information reproducing apparatus 1 in the first example. More specifically, in the information reproducing apparatus 2 in the second example, offset adjustment can be performed on the upper limit L1 and the lower limit L2 set on the amplitude limit value setting block 151. Hereinafter, the construction about the offset adjustment will be described in more detail.

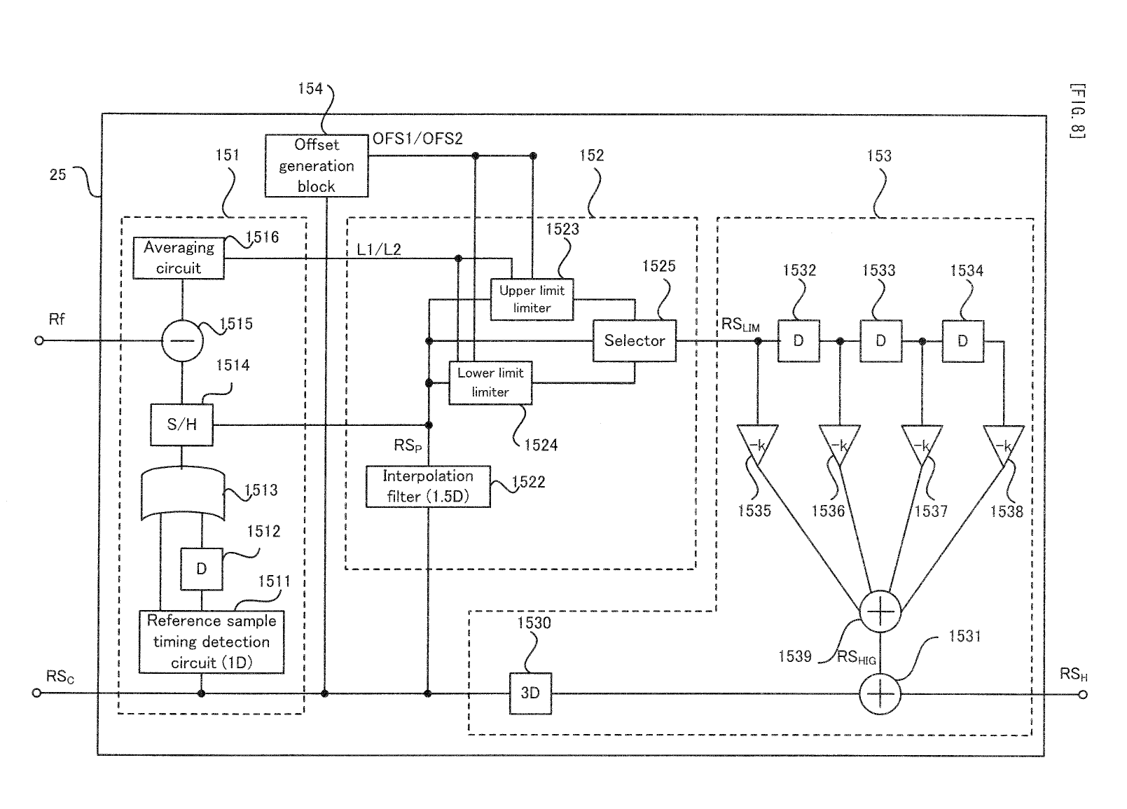

Next, with reference to FIG. 8, the more detailed structure of the limit equalizer 25 will be described. FIG. 8 is a block diagram conceptually showing the structure of the limit equalizer 25 in the second example.

As shown in FIG. 8, the limit equalizer 25 is provided with the amplitude limit value setting block 151; the amplitude limit block 152; the high-frequency emphasis block 153; and an offset calculation block 154, which constitutes one specific example of the “amplitude limiting device” of the present invention.

The offset calculation block 154 calculates an offset value OFS1, which is to be added to the upper limit L1 which is set on the amplitude limit value setting block 151, on the basis of the read sample value series RS_{C}. The upper limiter 1523 performs the amplitude limit on the read sample value series RS_{P}, with using the new upper limit L1 which is obtained by adding the offset value OFS1 calculated on the offset generation block 154 to the upper limit L1 set on the amplitude limit value setting block 151.

In the same manner, the offset generation block 154 calculates an offset value OFS2, which is added to the lower limit L2 which is set on the amplitude limit value setting block 151, on the basis of the read sample value series RS_{C}. The lower limiter 1524 performs the amplitude limit on the read sample value series RS_{P}, with using the new lower limit L2 which is obtained by adding the offset value OFS2 calculated on the offset generation block 154 to the lower limit L2 set on the amplitude limit value setting block 151.

Incidentally, an operation of calculating the offset values OFS1 and OFS2 can be considered in various aspects. Hereinafter, some aspects of the operation of calculating the offset values OFS1 and OFS2 are exemplified as one example.

(2-2) Calculation of Offset Values OFS1 and OFS2 Based On Value

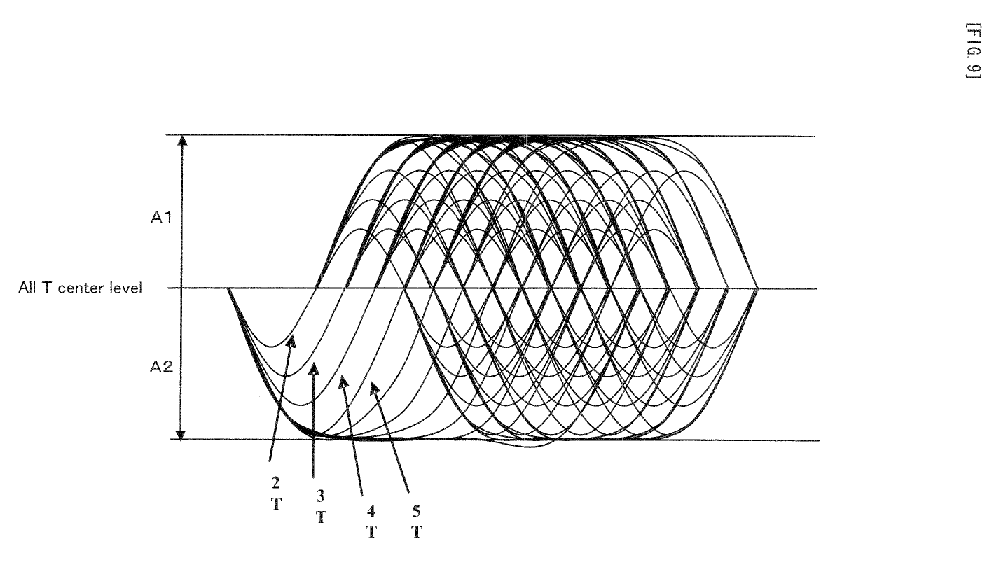

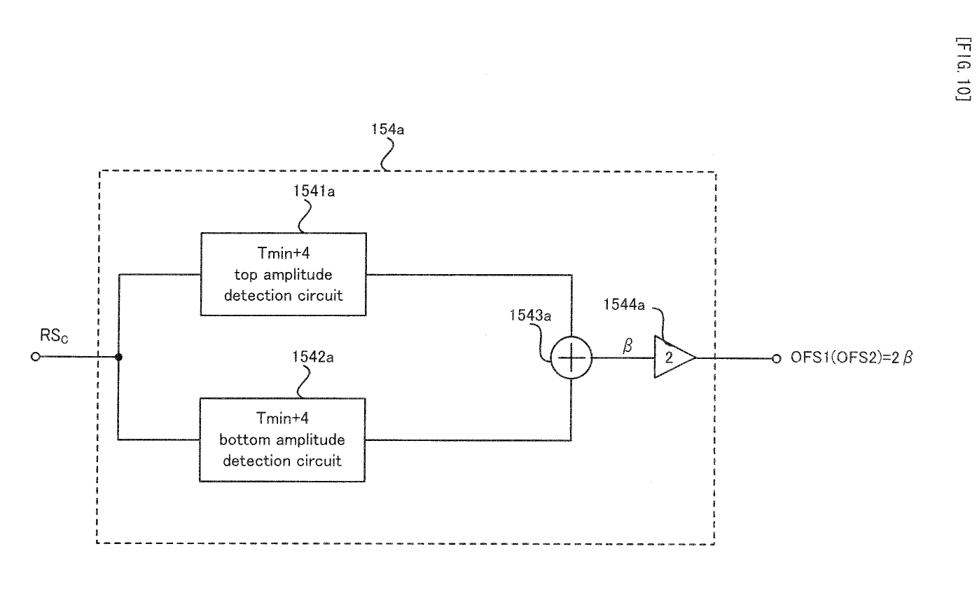

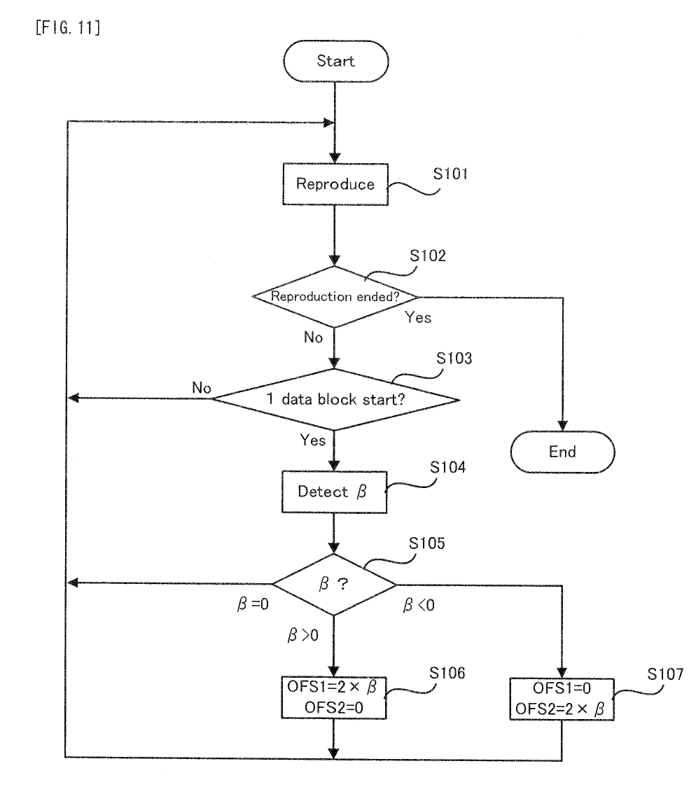

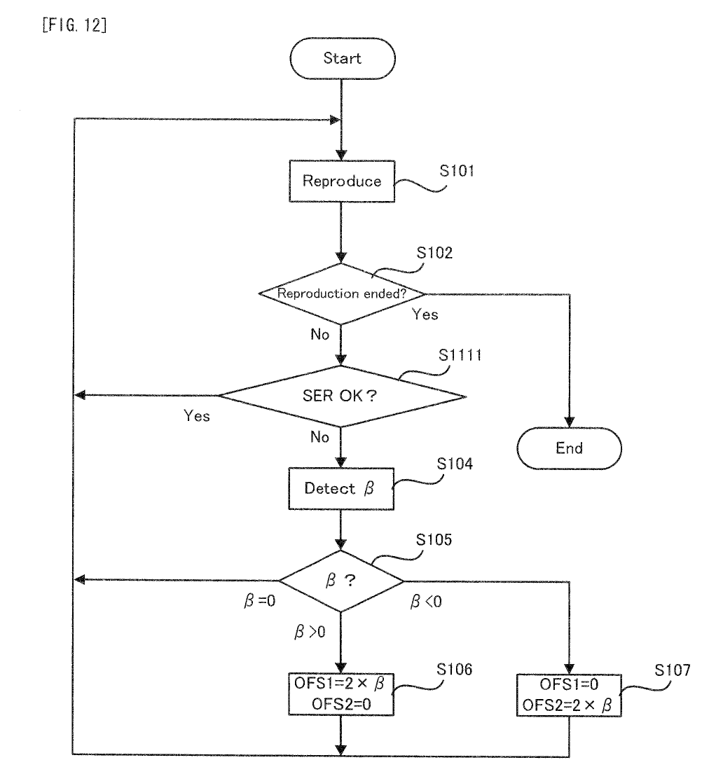

Firstly, with reference to FIG. 9 to FIG. 12, an explanation will be given on the operation of calculating the offset values OFS1 and OFS2 based on a value. FIG. 9 is a waveform chart conceptually slowing the value. FIG. 10 is a block diagram conceptually showing the structure of an offset calculation block 154a for calculating offset values OFS1 and OFS2 based on the value. FIG. 11 is a flowchart conceptually showing a flow of one operation of the information reproducing apparatus 2 in the second example when the offset values OFS1 and OFS2 based on the value are calculated. FIG. 12 is a flowchart conceptually showing a flow of another operation of the information reproducing apparatus 2 in the example when the offset values OFS1 and OFS2 based on the value are calculated.

As shown in FIG. 9, the value indicates the average position of the amplitude center of the read signals R_{RF} corresponding to the respective record data with all types of run lengths (e.g. the record data with each of run lengths of 3T to 11T and 14T if the optical disc 100 is a DVD, and the record data with each of run lengths of 2T to 9T if the optical disc 100 is a Blu-ray Disc). Specifically, (A1+A2)/(A1−A2), wherein A1 is the magnitude of the maximum amplitude (top amplitude) on the upper side (positive side) which is based on the amplitude center (i.e. all T center level) of the read signals R_{RF} corresponding to the record data with all types of run lengths (i.e. the amplitude center is set at the origin or base point) and A2 is the magnitude of the maximum amplitude (bottom amplitude) on the lower side (negative side) which is based on the amplitude center of the read signals R_{RF} corresponding to the record data with all types of run lengths. In other words, the value explained here is one specific example of the “entire value” of the present invention.

As shown in FIG. 10, the offset calculation block 154a is provided with a Tmin+4 top amplitude detection circuit 1541a, a Tmin+4 bottom amplitude detection circuit 1542a, an adder 1543a, and an amplifier 1544a. The sum of the top amplitude detected on the Tmin+4 top amplitude detection circuit 1541a and the bottom amplitude detected on the Tmin+4 bottom amplitude detection circuit 1542a is added on the adder 1543a. The output of the adder 1543a is the value which is not normalized by entire amplitudes. Moreover, the value amplified and doubled on the amplifier 1544a (i.e. 2) is the offset value OFS1 or OFS2 which is actually outputted to the upper limiter 1523 and the lower limiter 1524.

Incidentally, Tmin denotes the read signal R_{RF} (more specifically, the read sample value series RS_{C} corresponding to the read signal R_{RF}) corresponding to the record data with the shortest run length. Therefore, Tmin+4 denotes the read signal R_{RF}corresponding to the record data with the fifth shortest run length. For example, if the optical disc 100 is a DVD, Tmin+4 denotes the read signal R_{RF} corresponding to the record data with a run length of 7T. For example, if the optical disc 100 is a Blu-ray Disc, Tmin+4 denotes the read signal R_{RF} corresponding to the record data with a run length of 6T.

Here, Tmin+4 is used to simply show all the run lengths (i.e. for convenience of calculation). Thus, obviously, the same process (i.e. the process of calculating the sum of the top amplitude and the bottom amplitude) may be performed on all T and their average value may be set as the value.

The offset values OFS1 and OFS2 calculated in this manner may be added as needed during the reproduction operation. Specifically, as shown in FIG. 11, when the reproduction operation is performed (step S101), it is judged whether or not the reproduction operation is to be ended as occasion demands (step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (step S103).

As a result of the judgment in the step S103, if it is judged that the reproduction for one data block is not newly started (i.e. that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the value is calculated by the operation of the offset calculation block 154a (step S104). Then, it is judged whether the value is zero, the value is positive, or the value is negative (step S105).

As a result of the judgment in the step S105, if it is judged that the value is zero, OFS1 or OFS2 is zero. Therefore, without adding the offset values OFS1 and OFS2, the operational flow returns to the step S101, and the reproduction operation is continued.

As a result of the judgment in the step S105, if it is judged that the value is positive, OFS1 is set to 2, and OFS2 is set to zero (step S106). Therefore, the reproduction operation is continued, using the upper limit L1 obtained by adding the offset value OFS1 to the upper limit L1 that has been used.

As a result of the judgment in the step S105, if it is judged that the value is negative, OFS2 is set to 2, and OFS1 is set to zero (step S107). Therefore, the reproduction operation is continued, using the lower limit L2 obtained by adding the offset value OFS2 to the lower limit L2 that has been used.

Alternatively, the offset values OFS1 and OFS2 may be added when there is a reproduction error during the reproduction operation. Specifically, as shown in FIG. 12, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the value is calculated by the operation of the offset calculation block 154a (the step S104). Then, it is judged whether the value is zero, the value is positive, or the value is negative (the step S105). The subsequent operations are the same as in the example shown in FIG. 11.

As described above, by using the new upper limit L1 and the new lower limit L2 obtained by adding the offset values OFS1 and OFS2 corresponding to the value to the upper limit L1 and the lower limit L2, it is possible to receive the aforementioned various effects while eliminating the influence due to the value (i.e. the influence due to the deviation of the amplitude center).

Incidentally, if the value is not zero, instead of the operation of calculating the offset values OFS1 and OFS2 in the step S106 and the step S107 in FIG. 11 and FIG. 12, the upper limit L1 and the lower limit L2 may be set such that the sum of the upper limit L1 and the lower limit L2 is equal to the sum of the upper limit L1 and the lower limit L2 in the case where the value is assumed to be zero.

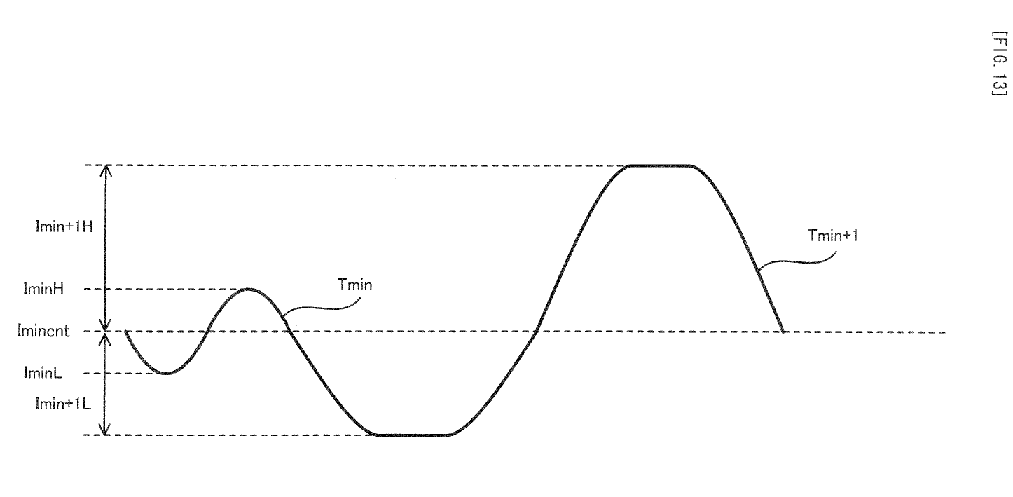

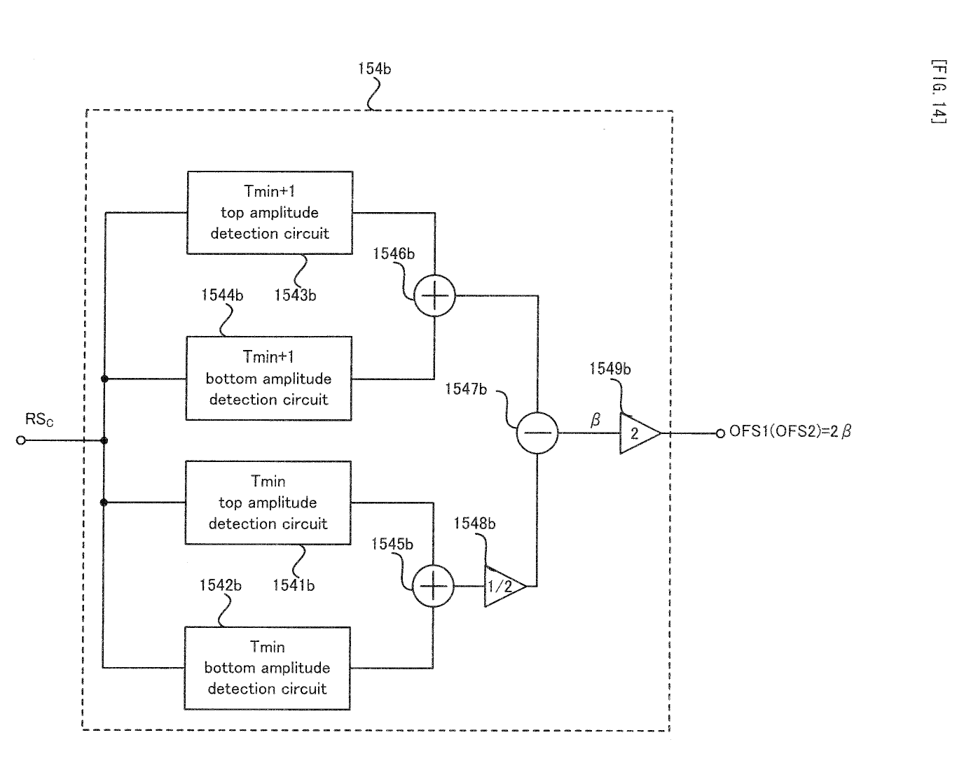

Moreover, the offset values OFS1 and OFS2 may be calculated on the basis of another value obtained from a different viewpoint from the value shown in FIG. 9. This construction will be explained with reference to FIG. 13 and FIG. 14. FIG. 13 is a waveform chart conceptually showing another value. FIG. 14 is a block diagram conceptually showing an offset calculation block 154b for calculating another value.

As shown in FIG. 13, another value indicates the deviation between the amplitude center of the read signals R_{RF} corresponding to the record data with the shortest run length and the amplitude center of the read signals R_{RF} corresponding to the record data with the second shortest run length. Specifically, another value=(Imin+1H+Imin+1L)/(Imin +1H−Imin+1L), wherein the amplitude center of the read signal corresponding to the record data with the shortest run length is IminCnt, Imin+1H indicates the magnitude of the top amplitude of the read signal R_{RF} corresponding to the record data with the second shortest run length based on IminCnt, and Imin+1L indicates the magnitude of the bottom amplitude of the read signal R_{RF} corresponding to the record data with the second shortest run length based on IminCnt. In other words, the value explained here is one specific example of the “partial value” of the present invention. Incidentally, IminCnt is an average value of the top amplitude value IminH and the bottom amplitude value IminL of the read signal R_{RF} corresponding to the record data with the shortest run length.

As shown in FIG. 14, an offset calculation block 154b is provided with a Tmin top amplitude detection circuit 1541b, a Tmin bottom amplitude detection circuit 1542b, a Tmin+1 top amplitude detection circuit 1543b, a Tmin+1 bottom amplitude detection circuit 1544b, adders 1545b and 1546b, a subtractor 1547b, an amplifier 1548b, and an amplifier 1549b. A difference is calculated on the subtractor 1547b wherein the difference is between a value obtained by amplifying the sum of the top amplitude detected on the Tmin top amplitude detection circuit 1541b and the bottom amplitude detected on the Tmin bottom amplitude detection circuit 1542b by ½ on the amplifier 1548b; and the sum of the top amplitude detected on the Tmin+1 top amplitude detection circuit 1543b and the bottom amplitude detected on the Tmin+1 bottom amplitude detection circuit 1544b. The output of the subtractor 1547b is another value that is not normalized by the amplitude of Tmin+1. Then, another value (i.e. 2) amplified and doubled on the amplifier 1549b is the offset value OFS1 or OFS2 actually outputted to the upper limiter 1523 and the lower limit 1524.

Incidentally, the upper limit L1 and the lower limit L2 of the amplitude limit value may be set by directly using another value. Specifically, with respect to the upper limit L1 and the lower limit L2 calculated by the operation in the first example (i.e. which is the average value of sample values), if the absolute value of the upper limit L1 is less than that of the lower limit L2, a value obtained by adding 2 to the absolute value of the upper limit L1 and further inverting its code may be set as the lower limit L1. In the same manner, with respect to the upper limit L1 and the lower limit L2 calculated by the operation in the first example, if the absolute value of the lower limit L2 is less than that of the upper limit L1, a value obtained by adding 2 to the absolute value of the lower limit L2 and further inverting its code may be set as the upper limit L1.

(2-3) Calculation of Offset Values OFS1 and OFS2 Based on Asymmetry Value

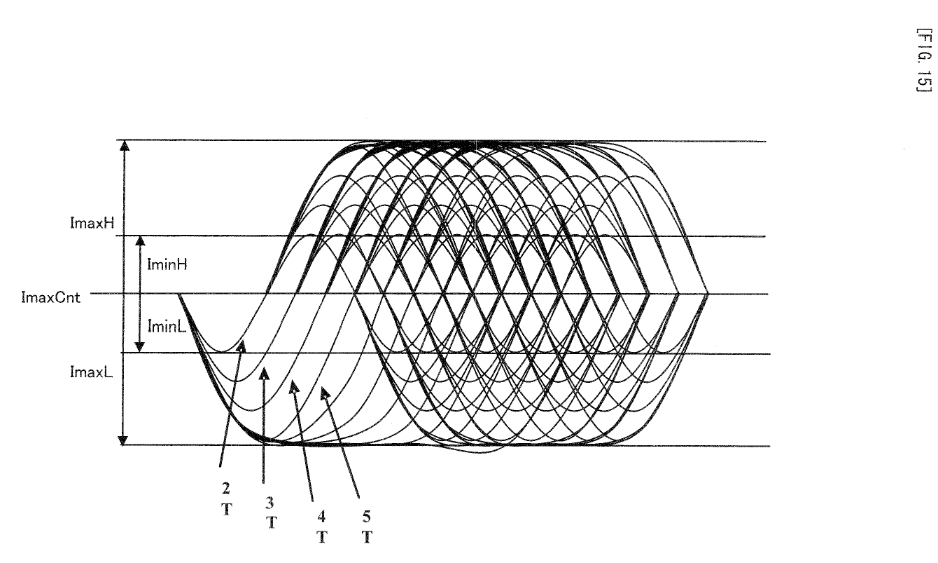

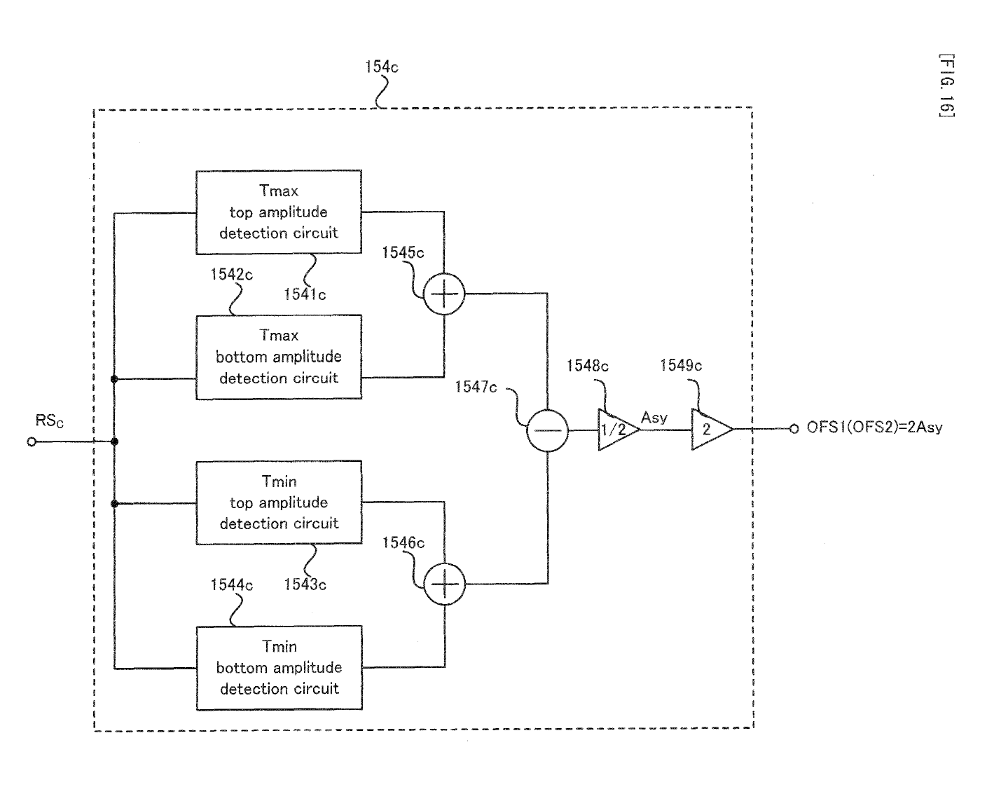

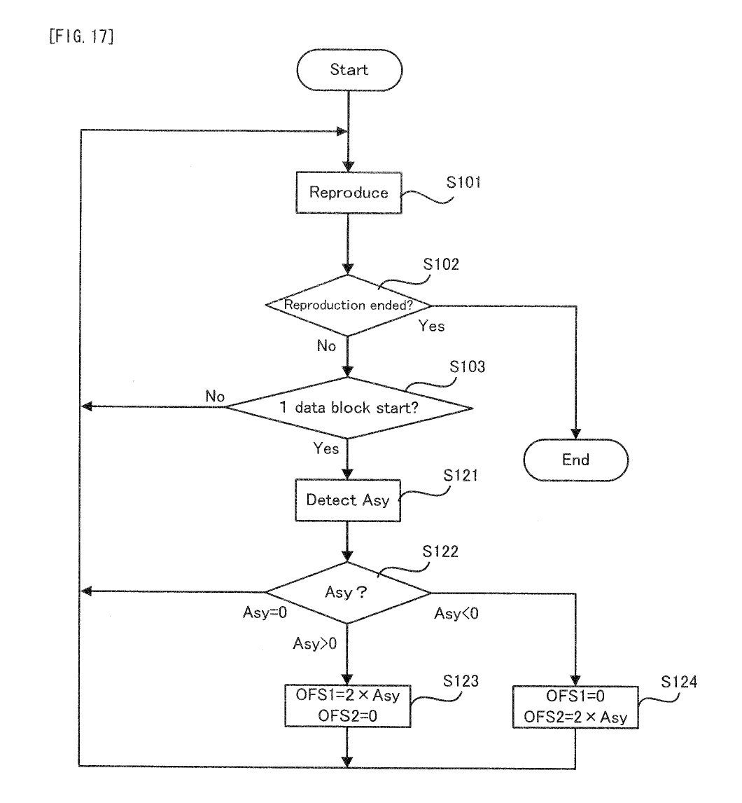

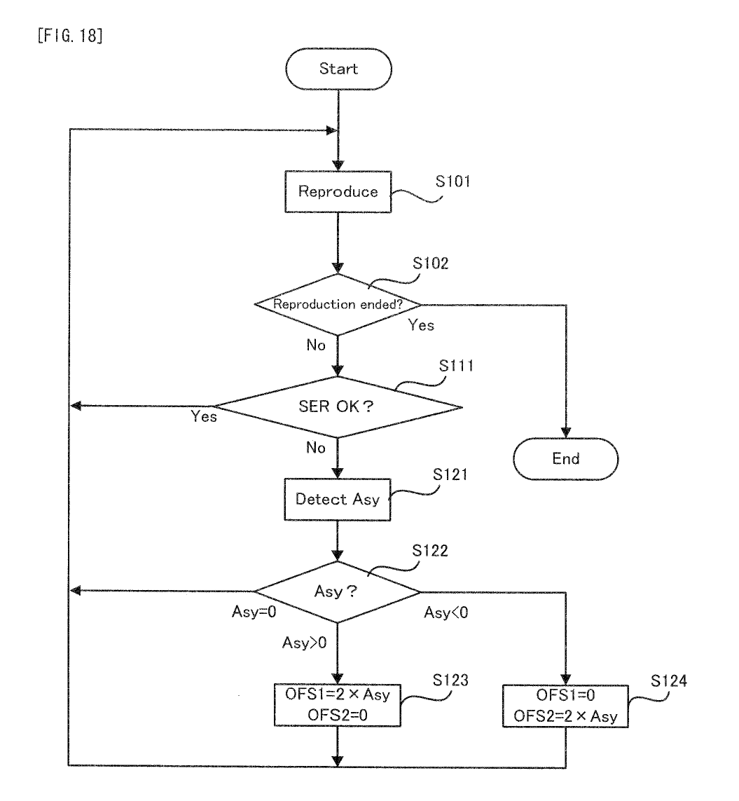

Next, with reference to FIG. 15 to FIG. 18, an explanation will be explained on the operation of calculating the offset values OFS1 and OFS2 based on an asymmetry value. FIG. 15 is a waveform chart conceptually showing the asymmetry value. FIG. 16 is a block diagram conceptually showing the structure of an offset calculation block 154c for calculating offset values OFS1 and OFS2 based on the asymmetry value. FIG. 17 is a flowchart conceptually showing a flow of one operation of the information reproducing apparatus 2 in the second example when the offset values OFS1 and OFS2 based on the asymmetry value are calculated. FIG. 18 is a flowchart conceptually showing a flow of another operation of the information reproducing apparatus 2 in the second example when the offset values OFS1 and OFS2 based on the asymmetry value are calculated.

As shown in FIG. 15, the asymmetry value indicates the deviation of the amplitude center of the read signal corresponding to the record data with the shortest run length, with respect to the amplitude center of the read signal R_{RF} corresponding to the record data with the longest run length. Specifically, the asymmetry value Asy=((ImaxH+ImaxL)−(IminH+IminL))/(2×(ImaxH−ImaxL)), wherein the amplitude center of the read signal R_{RF} corresponding to the data with the longest run length is ImaxCnt, ImaxH is the magnitude of the top amplitude of the read signal R_{RF} corresponding to the data with the longest run length based on ImaxCnt, ImaxL is the magnitude of the bottom amplitude of the read signal R_{RF} corresponding to the data with the longest run length based on ImaxCnt, IminH is the magnitude of the top amplitude of the read signal R_{RF} corresponding to the data with the shortest run length based on ImaxCnt, and IminL is the magnitude of the bottom amplitude of the read signal R_{RF} corresponding to the data with the shortest run length based on ImaxCnt. Incidentally, ImaxCnt is an average value of the top amplitude value and the bottom amplitude value of the read signal R_{RF} corresponding to the data with the longest run length.

As shown in FIG. 16, the offset calculation block 154c is provided with a Tmax top amplitude detection circuit 1541c, a Tmax bottom amplitude detection circuit 1542c, a Tmin top amplitude detection circuit 1543c, a Tmin bottom amplitude detection circuit 1544c, adders 1545c and 1546c, a subtractor 1547c, an amplifier 1548c, and an amplifier 1549c. A difference is calculated on the subtractor 1547c wherein the difference is between the sum of the top amplitude detected on the Tmax top amplitude detection circuit 1541c and the bottom amplitude detected on the Tmax bottom amplitude detection circuit 1542c; and the sum of the top amplitude detected on the Tmin top amplitude detection circuit 1543c and the bottom amplitude detected on the Tmin bottom amplitude detection circuit 1544c. At the same time, the output of the subtractor 1547c is halved on the amplifier 1548c. The output of the amplifier 1548c is the asymmetry value Asy. Then, the offset value OFS1 or OFS2 actually outputted to the upper limiter 1523 and the lower limiter 1524 is the asymmetry value Asy (i.e. 2Asy) amplified and doubled on the amplifier 1549c.

Incidentally, Tmax denotes the read signal R_{RF} corresponding to the record data with the longest run length (more specifically, the read sample value series RS_{C} corresponding to the read signal R_{RF}). For example, if the optical disc 100 is a DVD, Tmax denotes the read signal R_{RF} corresponding to the record data with a run length of 11T. For example, if the optical disc 100 is a Blu-ray Disc, Tmax denotes the read signal R_{RF} corresponding to the record data with a run length of 8T.

The offset values OFS1 and OFS2 calculated in this manner may be added as needed during the reproduction operation. Specifically, as shown in FIG. 17, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (the step S103).

As a result of the judgment in the step S103, if it is judged that the reproduction for one data block is not newly started (i.e. that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the asymmetry value Asy is calculated by the operation of the offset calculation block 154c (step S121). Then, it is judged whether the asymmetry value Asy is zero, the asymmetry value Asy is positive, or the asymmetry value Asy is negative (step S122).

As a result of the judgment in the step S122, if it is judged that the asymmetry value Asy is zero, OFS1 or OFS2 is zero. Therefore, without adding the offset values OFS1 and OFS2, the operational flow returns to the step S101, and the reproduction operation is continued.

As a result of the judgment in the step S122, if it is judged that the asymmetry value Asy is positive, OFS1 is set to 2Asy, and OFS2 is set to zero (step S123). Therefore, the reproduction operation is continued, using the upper limit L1 obtained by adding the offset value OFS1 to the upper limit L1 that has been used.

As a result of the judgment in the step S122, if it is judged that the asymmetry value Asy is negative, OFS2 is set to 2Asy, and OFS1 is set to zero (step S124). Therefore, the reproduction operation is continued, using the lower limit L2 obtained by adding the offset value OFS2 to the lower limit L2 that has been used.

Alternatively, the offset values OFS1 and OFS2 may be added when there is a reproduction error during the reproduction operation. Specifically, as shown in FIG. 18, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (the step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the asymmetry value Asy is calculated by the operation of the offset calculation block 154c (the step S121). Then, it is judged whether the asymmetry value Asy is zero, the asymmetry value Asy is positive, or the asymmetry value Asy is negative (the step S122). The subsequent operations are the same as in the example shown in FIG. 15.

As described above, by using the new upper limit L1 and the new lower limit L2 obtained by adding the offset values OFS1 and OFS2 corresponding to the asymmetry value Asy to the upper limit L1 and the lower limit L2, it is possible to receive the aforementioned various effects while eliminating the influence due the asymmetry value Asy (i.e. the influence due the deviation of the amplitude center).

(2-4) Calculation of Offset Values OFS1 and OFS2 Based On Waveform Distortion Amount

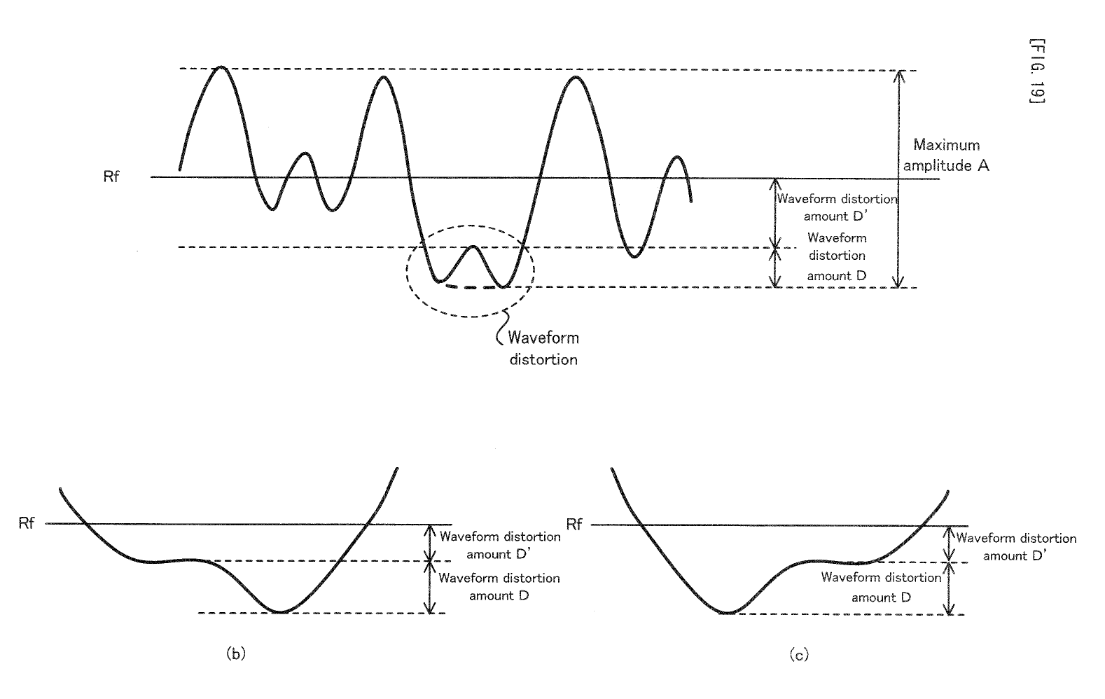

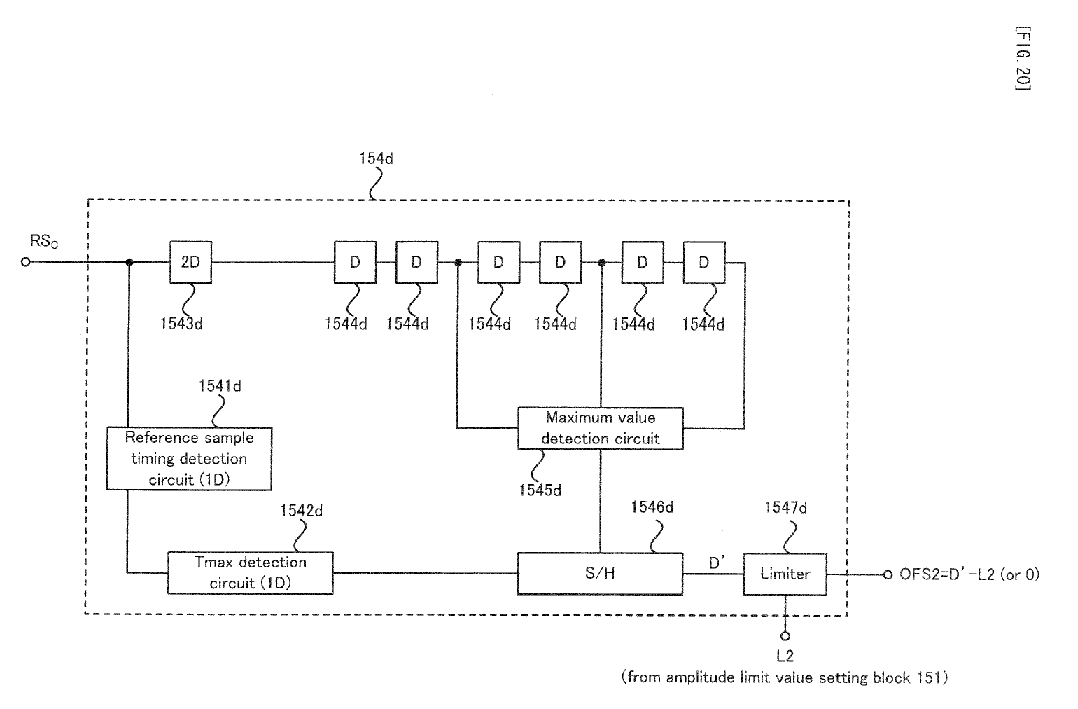

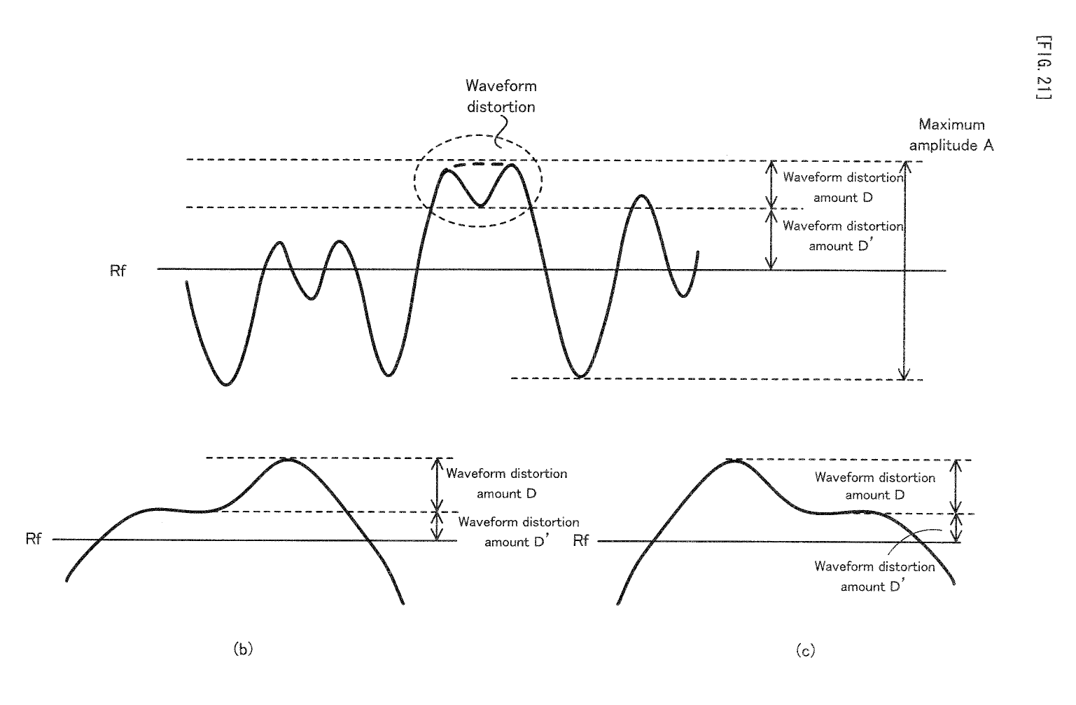

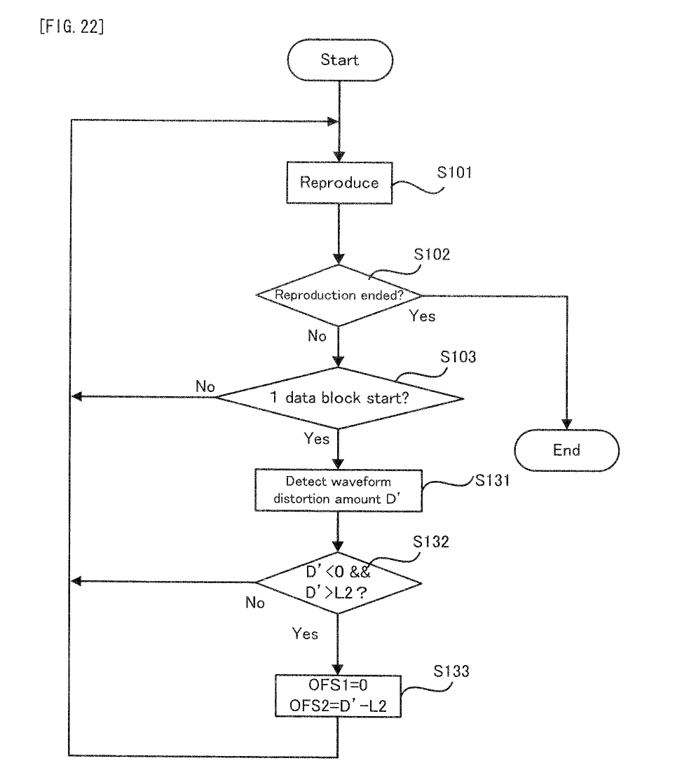

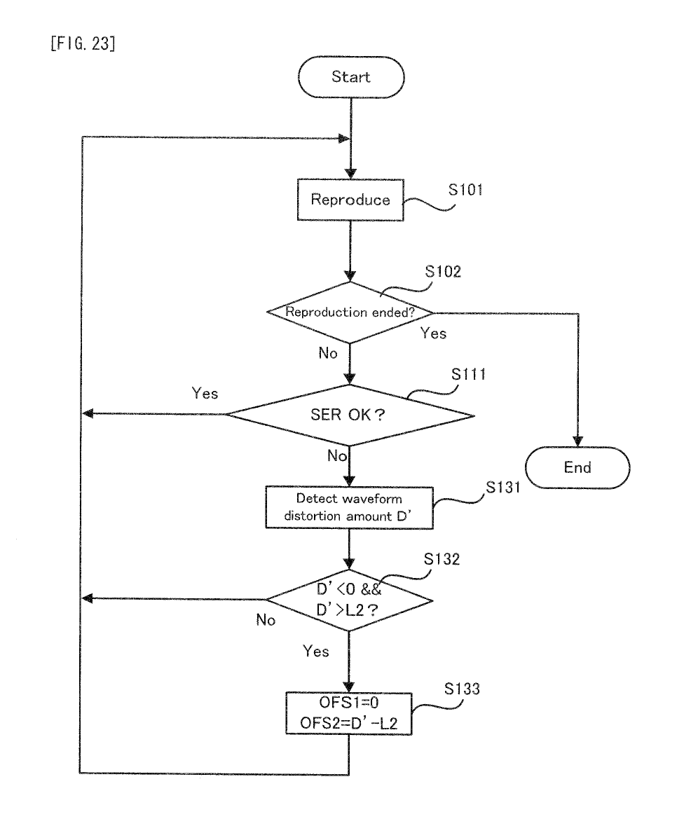

Next, with reference to FIG. 19 to FIG. 23, an explanation will be explained on the operation of calculating offset values OFS1 and OFS2 based on a waveform distortion amount. FIG. 19 is a waveform chart conceptually showing waveform distortion. FIG. 20 is a block diagram conceptually showing an offset calculation block 154d for calculating offset values OFS1 and OFS2 based on the waveform distortion amount. FIG. 21 is a waveform chart conceptually showing another waveform distortion. FIG. 22 is a flowchart conceptually showing a flow of one operation of the information reproducing apparatus 2 in the second example when .the offset values OFS1 and OFS2 based on the waveform distortion amount are calculated. FIG. 23 is a flowchart conceptually showing a flow of another operation of the information reproducing apparatus 2 in the second example when the offset values OFS1 and OFS2 based on the waveform distortion are calculated.

As shown in FIG. 19(a), the waveform distortion indicates a difference between a proper signal level and a signal level that actually appears in the read signal R_{RF}. The waveform distortion is quantitatively defined by a waveform distortion amount D with respect to the maximum amplitude A of the read signal R_{RF}, and a waveform distortion amount D′ which is a signal level from a reference level to the peak of the waveform distortion. In FIG. 19(a), a thick dashed line indicates the proper signal level when there is no waveform distortion. If there is no waveform distortion, the waveform distortion amount D is obviously zero.

Incidentally, the waveform distortion shown in FIG. 19(a) indicates the waveform distortion that the signal level in a middle portion is changed, compared to the signal level in a front edge portion and a rear edge portion of the read signal R_{RF}. Apart from such waveform distortion, there can be the waveform distortion that the signal level in the front edge portion and the middle portion is changed, compared to the signal level in the rear edge portion of the read signal R_{RF} as shown in FIG. 19(b); and the waveform distortion that the signal level in the middle edge portion and the rear portion is changed, compared to the signal level in the front edge portion of the read signal R_{RF} as shown in FIG. 19(c). For any waveform distortion, the structure and operation described later can be obviously adopted.

Moreover, in the example, it is preferable to focus on the waveform distortion which occurs in the read signal corresponding to the record mark with a relatively long run length (e.g. data with a run length of 11T if the optical disc 100 is a DVD, and data with a run length of 8T if the optical disc 100 is a Blu-ray Disc).

As shown in FIG. 20, the offset calculation block 154d is provided with a reference sample timing detection circuit 1541d, a Tmax detection circuit 1542d, a delay circuit 1543d for providing a two-clock delay, a plurality of delay circuits 1544d each of which provides a one-clock delay, a maximum value detection circuit 1545d, a sample hold circuit 1546d, and a limiter 1547d.

The read sample value series RS_{C} inputted to the offset calculation block 154d is outputted to each of the reference sample timing detection circuit 1541d and the delay circuit 1543d. On the reference sample timing detection circuit 1541d, reference sample timing is detected on the basis of the read sample value series RS_{C}. The detected reference sample timing is used for an operation of detecting Tmax (specifically, an operation of detecting the sample value corresponding to Tmax) on the Tmax detection circuit 1542d. Tmax detected on the Tmax detection circuit 1542d is outputted to the sample hold circuit 1546d. On the other hand, a two-clock delay is provided to the read sample value series RS_{C} on the delay circuit 1543d. Then, the read sample value series RS_{C} is outputted to the maximum value detection circuit 1545d by the operations of the delay circuits 1544d every time a two-clock delay is provided. In other words, the signal level in the front edge portion, the signal level in the middle portion, and signal level in the rear edge portion shown in FIG. 19 are outputted to the maximum detection circuit 1545d. Therefore, the maximum signal level (i.e. the waveform distortion amount D′ shown in FIG. 19) of the signal level in the front edge portion, the signal level in the middle portion, and signal level in the rear edge portion is outputted from the maximum detection circuit 1545d. Then, on the sample hold circuit 1546d, Tmax detected on the Tmax detection circuit 1542d is sampled and held by the output of the maximum detection circuit 1545d, and as a result, the waveform distortion amount D′ is obtained. The waveform distortion amount D′ obtained in this case is used in the calculation of the offset value OFS2 outputted to the lower limiter 1524. The offset value OFS2 actually outputted to the lower limiter 1524 is D′−L2 if D′>L2 and it is zero if D′ L2, by the limiter 1547d which performs level limit according to the lower limit L2 of the amplitude limit value outputted from the amplitude limit value setting block 151.

Incidentally, here, an explanation was given on the operation aimed at the optical disc 100 in which the reflectance of the laser beam LB is reduced by recording the record data. In other words, an explanation was given on the operation aimed at the case where the waveform distortion occurs such that the signal level unintentionally increases, in the signal level which is the reference level or less. However, the operation may be aimed at the optical disc 100 in which the reflectance of the laser beam LB is increased by recording the record data. In other words, as shown in FIG. 21(a) to FIG. 21(c), it may be aimed at the case where the waveform distortion occurs such that the signal level unintentionally reduces, in the signal level which is the reference level or more. In this case, the maximum detection circuit 1545d in the offset calculation block 154d shown in FIG. 20 is replaced by a minimum value detection circuit 1547d, and the limiter 1547d perform level limit according to the upper limit L1 of the amplitude limit value outputted from the amplitude limit value setting block 151. Moreover, the waveform distortion amount D′ obtained in this case is used in the calculation of the offset value OFS1 outputted to the upper limiter 1523. The offset value OFS1 actually outputted to the upper limiter 1523 is D′−L1 if D′<L1 and it is zero if D′. L1, by the limiter 1547d which performs level limit according to the upper limit L1 of the amplitude limit value outputted from the amplitude limit value setting block 151.

The offset values OFS1 and OFS2 calculated in this manner may be added as needed during the reproduction operation. Specifically, as shown in FIG. 22, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not the reproduction for one data block is newly started (the step S103).

As a result of the judgment in the step S103, if it is judged that the reproduction for one data block is not newly started (i.e. if it is judged that the past reproduction for the data block is continued) (the step S103: No), the operational flow returns to the step S101, and the reproduction operation is continued.

On the other hand, as a result of the judgment in the step S103, if it is judged that the reproduction for one data block is newly started (the step S103: Yes), then, the waveform distortion amount D is calculated by the operation of the offset calculation block 154d (step S131). Then, it is judged whether or not the waveform distortion amount D is less than zero and is greater than the lower limit L2 (step S132).

As a result of the judgment in the step S103, if it is judged that the waveform distortion amount D is not less than zero and is less than or equal to the lower limit L2 (the step S132: No), OFS1 and OFS2 are zero. Therefore, without adding the offset values OFS1 and OFS2, the operational flow returns to the step S101, and the reproduction operation is continued.

On the other hand, as a result of the judgment in the step S103, if it is judged that the waveform distortion amount D is less than zero and is greater than the lower limit L2 (the step S132: Yes), OFS1 is set to zero, and OFS2 is set to D′−L2 (step S133). Therefore, the reproduction operation is continued, using the lower limit L2 obtained by adding the offset value OFS2 to the lower limit L2 that has been used.

Incidentally, here, an explanation was given on the operation aimed at the optical disc 100 in which the reflectance of the laser beam LB is reduced by recording the record data. However, the operation may be aimed at the optical disc 100 in which the reflectance of the laser beam LB is increased by recording the record data. In this case, in the step S132, it is judged whether or not the waveform distortion amount D′ is greater than zero and is less than the upper limit L1 (step S132). Moreover, in the step S133 performed if it is judged that the waveform distortion amount D′ is greater than zero and is less than the upper limit L1, OFS1 is set to D′−L1, and OFS2 is set to zero.

Alternatively, the offset values OFS1 and OFS2 may be added when there is a reproduction error during the reproduction operation. Specifically, as shown in FIG. 23, when the reproduction operation is performed (the step S101), it is judged whether or not the reproduction operation is to be ended as occasion demands (the step S102).

As a result of the judgment in the step S102, if it is judged that the reproduction operation is to be ended (the step S102: Yes), the reproduction operation is ended as it is.

On the other hand, as a result of the judgment in the step S102, if it is judged that the reproduction operation is not to be ended (the step S102: No), then, it is judged whether or not a value of SER (Symbol Error Rate) is normal (step S111).

As a result of the judgment in the step S111, if it is judged that the value of SER is normal (the step S111: Yes), the operational flow returns to the step S101, and the reproduction operation is continued.

On the other hand, as a result of the judgment in the step S111, if it is judged that the value of SER is not normal (the step S111: No), then, the waveform distortion amount D′ is calculated by the operation of the offset calculation block 154d (the step S131). Then, it is judged whether or not the waveform distortion amount D′ is less than zero and is greater than the lower limit L2 (the step S132). The subsequent operations are the same as in the example shown in FIG. 15.

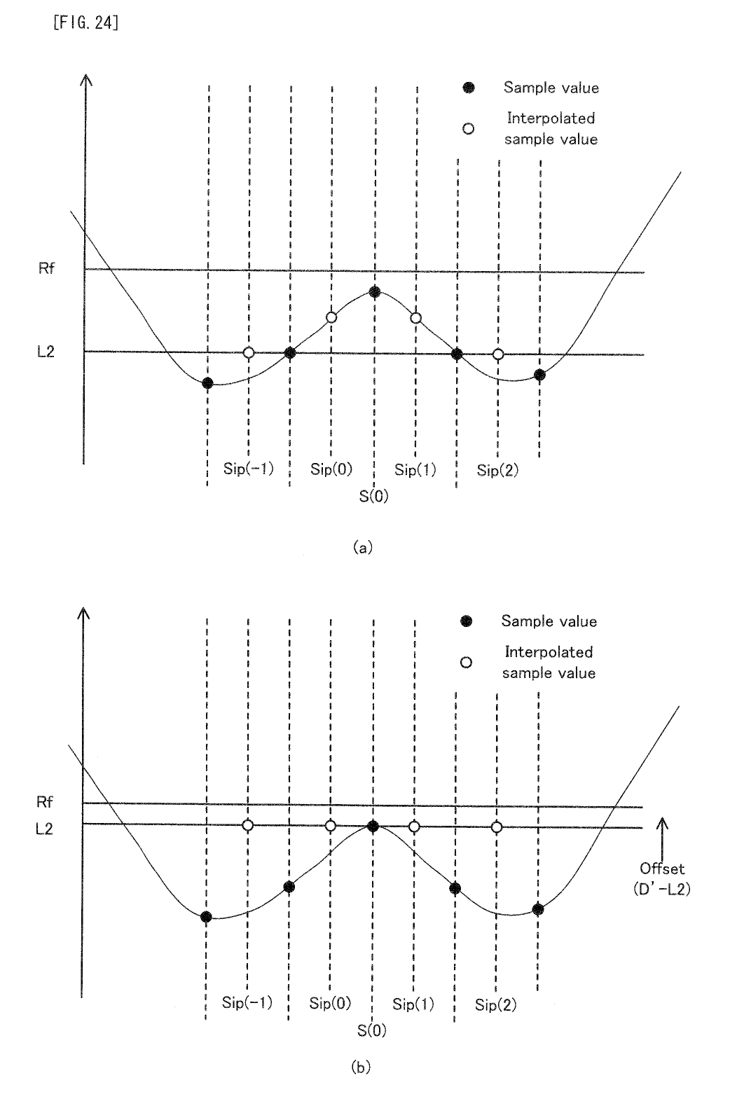

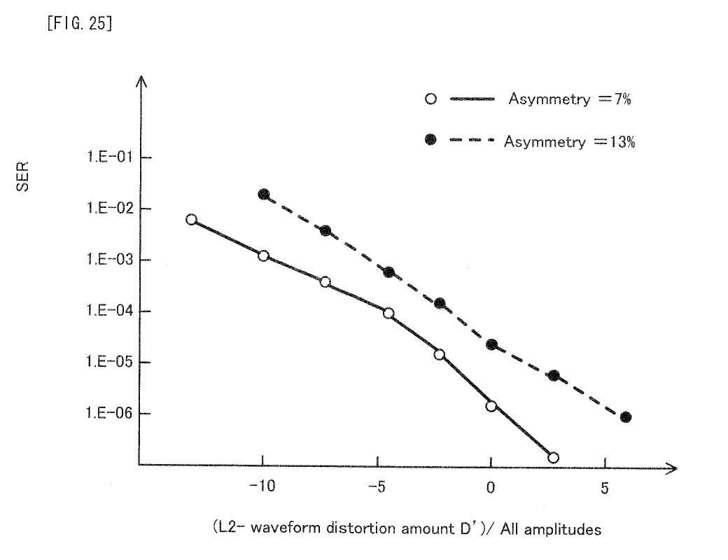

As described above, by using the new upper limit L1 and the new lower limit L2 obtained by adding the offset values OFS1 and OFS2 corresponding to the waveform distortion amount D′ to the upper limit L1 and the lower limit L2, it is possible to receive the aforementioned various effects while eliminating the influence due to the waveform distortion amount D′. The effect that the influence due to the waveform distortion is eliminated will be explained with reference to FIG. 24 and FIG. 25. FIG. 24 are waveform charts conceptually showing an operation of obtaining a high-frequency emphasized read sample value series RS_{H}, in each of a case where the upper limit L1 and the lower limit L2 of the amplitude limit value are set in the method in the background art and a case where the upper limit L1 and the lower limit L2 of the amplitude limit value are set individually FIG. 25 is a graph showing a change in symbol error rate with respect to a positional relation between the upper limit L1 or lower limit L2 of the amplitude limit value and the waveform distortion.

As shown in FIG. 24(a), if there is the waveform distortion, the waveform distortion may have a signal level that is greater than the lower limit L2 of the amplitude limit value. Here, it is assumed that the operations by the amplitude limit block 152 and the high-frequency emphasis block 153 are performed without adding the offset value OFS2 corresponding to the waveform distortion amount D′. In this case, the high-frequency emphasized read sample value series RS_{H} outputted from the high-frequency emphasis block 153 is the sum of the high-frequency read sample value series RS_{HIG} and S(0), and as described above, RS_{HIG}=(−k)×Sip(−1)+k×Sip(0)+k×Sip(1)+(−k)×Sip(2). Here, since Sip(−1) and Sip(2) are limited by the lower limit L2, RS_{H}=S(0) 30 k×(−2×L2+Sip(0)+Sip(1)). This increases the value of the high-frequency emphasized read sample value series RS_{H}, by the value obtained by multiplying the sum of the lower limit L2, Sip (0), and Sip(1) by K. This is not preferable because it emphasizes the waveform distortion which is originally not to occur.

On the other hand, as shown in FIG. 24(b), it is assumed that the operations by the amplitude limit block 152 and the high-frequency emphasis block 153 are performed by adding the offset value OFS2 corresponding to the waveform distortion amount D′. In this case, the new lower limit L2 is a value obtained by adding OFS2=D′−L2′ to the lower limit L2 that has been used (here, referred to as L2′ to easily understand). Therefore, the new lower limit L2 is D′. In other words, the new lower limit L2 does not cross the waveform corresponding to the waveform distortion. In other words, the addition of the offset value OFS2 is performed in order not to make the lower limit L2 cross the waveform distortion. Thus, since Sip(−1), Sip(0), Sip(1), and Sip(2) are limited by the lower limit L2, RS_{H}=S(0). Thus, it is possible to prevent the disadvantage of the emphasized waveform distortion.

As described above, the effect of the information reproducing apparatus 2 that the offset values OFS1 and OFS2 corresponding to the waveform distortion amount D′ are added to the upper limit L1 or the lower limit L2 is also seen from a change in symbol error rate with respect to the positional relation between the upper limit L1 or lower limit L2 of the amplitude limit value and the waveform distortion. As shown in FIG. 25, compared to the case where the lower limit L2 and the waveform distortion cross each other (i.e. if L2—the waveform distortion amount D′ is negative), the value of SER is improved in the case where the lower limit L2 and the waveform distortion do not cross each other (i.e. if L2—the waveform distortion amount D′ is positive). Of course, the same is true for a change in symbol error rate with respect to the positional relation between the upper limit L1 and the waveform distortion.

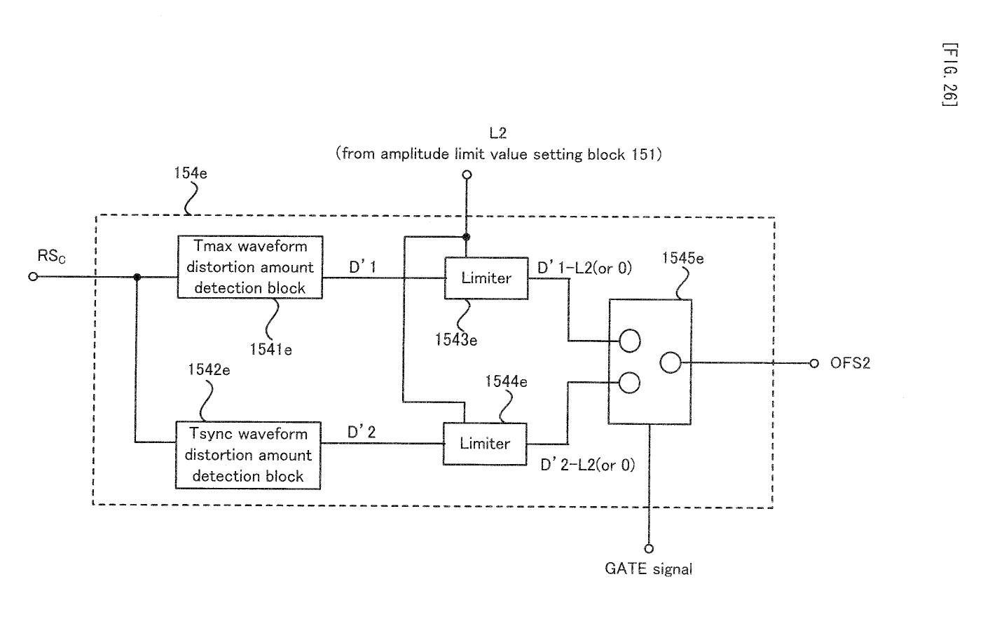

Incidentally, the record data recorded on the optical disc 100 includes not only normal user data but also synchronization data (e.g. the record data with a run length of 14T if the optical disc 100 is a DVD, and the record data with a run length of 9T if the optical disc 100 is a Blu-ray Disc) used for synchronization in reproducing the user data. In view of that the synchronization data is included in the record data, the offset values OFS1 and OFS2 may be calculated on the basis of the waveform distortion amount D′, using construction shown in FIG. 26. FIG. 26 is a block diagram conceptually showing the structure of an offset calculation block 154e for calculating offset values OFS1 arid OFS2 on the basis of the waveform distortion amount D′ in view of that the synchronization data is included in the record data.

As shown in FIG. 26, the offset calculation block 154e is provided with a Tmax waveform distortion amount detection block 1541e, a Tsync waveform distortion detection block 1542e, a limiter 1543e, a limiter 1544e, and a selector 1545e.

The Tmax waveform distortion amount detection circuit 1541e has the same structure as that of the aforementioned offset calculation block 154d. In other words, the Tmax waveform distortion amount detection circuit 1541e detects a waveform distortion amount D′1 of the read signal corresponding to the record data with a run length of Tmax.

The Tsync waveform distortion detection circuit 1542e has such a structure that the Tmax detection circuit 1542d of the aforementioned offset calculation block 154d is replaced by a Tsync detection circuit, In other words, the Tsync waveform distortion detection circuit 1542e detects a waveform distortion amount D′2 of the read signal corresponding to the record data with a run length of Tsync.

Incidentally, Tsync indicates the read signal R_{RF} (more specifically, the read sample value series RS_{C} corresponding to the read signal R_{RF}) corresponding to the synchronization data (in other words, sync data). For example, Tsync is the read signal R_{RF} corresponding to the record data with a run length of 14T if the optical disc 100 is a DVD. For example, Tsync is the read signal R_{RF} corresponding to the record data with a run length of 9T if the optical disc 100 is a Blu-ray Disc.

The waveform distortion amount D′1 detected on the Tmax waveform distortion amount detection circuit 1541e is subjected to the limit by the lower limit L2 which is set by the amplitude limit value setting clock 151, on the limiter 1543e. In other words, if the waveform distortion amount D′1 has a value of the lower limit L2 or less (i.e. if the waveform distortion of the read signal of Tmax does not cross the lower limit L2), zero is outputted as the offset value OFS2 to the selector 1545e. If the waveform distortion amount D′1 has a value of the lower limit L2 or more (i.e. if the waveform distortion of the read signal of Tmax crosses the lower limit L2), D′1−L2 is outputted as the offset value OFS2 to the selector 1545e.

In the same manner, the waveform distortion amount D′2 detected on the Tsync waveform distortion detection circuit 1542e is subjected to the limit by the lower limit L2 which is set by the amplitude limit value setting clock 151, on the limiter 1544e. In other words, if the waveform distortion amount D′2 has a value of the lower limit L2 or less (i.e. if the waveform distortion of the read signal of Tsync does not cross the lower limit L2), zero is outputted as the offset value OFS2 to the selector 1545e. If the waveform distortion amount D′2 has a value of the lower limit L2 or more (i.e. if the waveform distortion of the read signal of Tsync crosses the lower limit L2), D′2−L2 is outputted as the offset value OFS2 to the selector 1545e.

On the selector 1545e, the offset value OFS2 is outputted by changing the output of each of the limiter 1543e and the limiter 1544e as occasion demands, on the basis of a GATE signal having a rising pulse in timing that the synchronization data appears. Specifically, in the timing that there is no rising pulse by the GATE signal (i.e. in the timing that the normal user data is reproduced), the output of the limiter 1543e is outputted as the offset value OFS2. On the other hand, in the timing that there is a rising pulse by the GATE signal (i.e. in the timing that the synchronization data is reproduced), the output of the limiter 1544e is outputted as the offset value OFS2.

As described above, by calculating the offset values OFS1 and OFS2 on the basis of the waveform distortion amount D′ in view of that the synchronization data is included in the record data, it is possible to preferably perform high-frequency emphasis on the synchronization data, which is more important than the user data, resulting in preferable reproduction of the synchronization data. By this, it is possible to further improve stability in the reproduction operation.

Incidentally, in the explanation in FIG. 26, an explanation was given on the operation aimed at the optical disc 100 in which the reflectance of the laser beam LB is reduced by recording the record data. However, it may be aimed at the optical disc 100 in which the reflectance of the laser beam LB is increased by recording the record data. In this case, each of the limiters 1543e and 1544e in the offset calculation block 154e shown in FIG. 26 performs the level limit according to the upper limit L1 of the amplitude limit value outputted from the amplitude limit value setting block 151. Thus, if the waveform distortion amount D′1 has a value of the upper limit L1 or more (i.e. the waveform distortion of the read signal of Tmax does not cross the upper limit L1), zero is outputted as the offset value OFS1 to the selector 1545e from the limiter 1543e. If the waveform distortion amount D′1 has a value of the upper limit L1 or less (i.e. the waveform distortion of the read signal of Tmax crosses the upper limit L1), D′1-L1 is outputted as the offset value OFS1 to the selector 1545e. In the same manner, if the waveform distortion amount D′2 has a value of the upper limit L1 or more (i.e. the waveform distortion of the read signal of Tmax does not cross the upper limit L1), zero is outputted as the offset value OFS1 to the selector 1545e from the limiter 1544e. If the waveform distortion amount D′2 has a value of the upper limit L1 or less (i.e. the waveform distortion of the read signal of Tmax crosses the upper limit L1), D′1−L1 is outputted as the offset value OFS1 to the selector 1545e.

Moreover, in the example shown in FIG. 26, the offset values OFS1 and OFS2 are calculated by changing the waveform distortion amount D1 of the user data and the waveform distortion amount D2 of the synchronization data, as occasion demands. However, with emphasis on the importance of the synchronization data, the offset values OFS1 and OFS2 may be calculated by always using the waveform distortion amount D2 of the synchronization data.

Incidentally, in the second example, 2Asy, 2, and D are used as they are as the offset values OFS1 and OFS2. However, an appropriate value maybe also set as the offset values OFS1 and OFS2 in accordance with the asymmetry value Asy, the value, and the waveform distortion amount D′ which are detected. In other words, a value specified by a predetermined function or the like which uses the asymmetry value Asy, the value, and the waveform distortion amount D′ as variables may be set as the offset values OFS1 and OFS2.

Moreover, in the second example, an explanation was given on the construction that the offset value OFS1 or OFS2 calculated in accordance with the asymmetry value, the value, and the waveform distortion amount is added to the upper limit L1 or the lower limit L2; however, an arbitrary offset value may be added. Alternatively, the upper limit L1 and the lower limit L2 may be set to arbitrary values. In this case, the upper limit L1 is preferably greater than the read signal corresponding to the record data with the shortest run length and is less than the read signal corresponding to the record data with the second shortest run length. Moreover, the lower limit L2 is preferably less than the read signal corresponding to the record data with the shortest run length and is greater than the read signal corresponding to the record data with the second shortest run length.

Incidentally, the aforementioned explanation describes the optical disc 100 in which the reflectance of the laser beam is reduced by recording the data. However, obviously, the same operation may be performed on an optical disc in which the reflectance of the laser beam is increased by recording the data.

The present invention is not limited to the aforementioned examples, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

1. An information reproducing apparatus comprising:
an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, said amplitude limiting device individually setting each of an upper limit and a lower limit of the amplitude limit value.

2. The information reproducing apparatus according to claim 1, wherein the upper limit of the amplitude limit value is an average value of sample values which are before or after a reference sample point of the read signal and which have a value greater than or equal to a reference level.

3. The information. reproducing apparatus according to claim 1, wherein the lower limit of the amplitude limit value is an average value of sample values which are before or after a reference sample point of the read signal and which have a value less than or equal to a reference level.

4. The information reproducing apparatus according to claim 1, wherein the upper limit of the amplitude limit value is greater than a signal level of a read signal obtained by reading record data with the shortest run length of the read signal, and the upper limit of the amplitude limit value is less than a signal level of a read signal obtained by reading the record data with the second shortest run length of the read signal

5. The information reproducing apparatus according to claim 1, wherein the lower limit of the amplitude limit value is less than a signal level of a read signal obtained by reading record data with the shortest run length of the read signal, and the lower limit of the amplitude limit value is greater than a signal level of a read signal obtained by reading the record data with the second shortest run length of the read signal

6. The information reproducing apparatus according to claim 1, wherein at least one of the upper limit and the lower limit of the amplitude limit value is set in accordance with at least one of (i) an asymmetry value which indicates a shift amount of an amplitude center of a read signal obtained by reading record data with the shortest run length of the read signal, with respect to a maximum amplitude of a read signal obtained by reading the record data with the longest run length of the read signal; (ii) an entire β value which indicates an average value of the amplitude center of the read signal; and (iii) a partial β value which indicates deviation of the amplitude center of the read signal obtained by reading the record data with the shortest run length of the read signal and the amplitude center of the read signal obtained by reading the record data with the second shortest run length of the read signal.

7. The information reproducing apparatus according to claim 6, wherein the upper limit of the amplitude limit value is set by adding an offset value which is set in accordance with at least one of the asymmetry value, the entire β value, and the partial β value, to an average value of sample values which are before or after a reference sample point of the read signal and which have a value greater than or equal to a reference level.

8. The information reproducing apparatus according to claim 6, wherein the lower limit of the amplitude limit value is set by adding an offset value which is set in accordance with at least one of the asymmetry value, the entire β value, and the partial β value, to an average value of sample values which are before or after a reference sample point of the read signal and which have a value less than or equal to a reference level.

9. The information reproducing apparatus according to claim 6, wherein out of an average value of sample values which are before or after a reference sample point of the read signal and which have a value greater than or equal to a reference level and an average value of sample values which are before or after the reference sample point of the read signal and which have a value less than or equal to the reference level, a value having a smaller absolute value is set as one of the upper limit and the lower limit of the amplitude limit value, and a value which is obtained by adding the doubled partial β value to the value having the smaller absolute value out of the two average values is set as the other of the upper limit and the lower limit of the amplitude limit value.

10. The information reproducing apparatus according to claim 6. wherein at least one of the upper limit and the lower limit of the amplitude limit value is set such that a sum of the upper limit and the lower limit of the amplitude limit value is equal to a sum of the upper limit and the lower limit of the amplitude limit value in the case where the entire β value is zero.

11. The information reproducing apparatus according to claim 1, wherein at least one of the upper limit and the lower limit of the amplitude limit value is set in accordance with a waveform distortion amount which is amount of waveform distortion of the read signal.

12. The information reproducing apparatus according to claim 11, wherein the upper limit of the amplitude limit value is set by adding an offset value which is set in accordance with the waveform distortion amount, to an average value of sample values which are before or after a reference sample point of the read signal and which have a value greater than or equal to a reference level.

13. The information reproducing apparatus according to claim 11, wherein the lower limit of the amplitude limit value is set by adding an offset value which is set in accordance with the waveform distortion amount, to an average value of sample values which are before or after a reference sample point of the read signal and which have a value less than or equal to a reference level.

14. The information reproducing apparatus according to claim 11, wherein at least one of the upper limit and the lower limit of the amplitude limit value is set such that each of the upper limit and the lower limit of the amplitude limit value does not cross the waveform distortion.

15. The information reproducing apparatus according to claim 11, wherein said amplitude limiting device sets at least one of the upper limit and the lower limit of the amplitude limit value in limiting the amplitude level of the read signal corresponding to user data out of record data, in accordance with the waveform distortion amount of the read signal corresponding to the user data, and said amplitude limiting device sets at least one of the upper limit and the lower limit of the amplitude limit value in limiting the amplitude level of the read signal corresponding to synchronization data out of record data, in accordance with the waveform distortion amount of the read signal corresponding to the synchronization data, the synchronization data being for synchronization in reproducing the user data.

16. An information reproducing method comprising:
an amplitude limiting process of obtaining an amplitude limit signal by limiting an amplitude level of a read signal read from a recording medium on the basis of a predetermined amplitude limit value; and a filtering process of obtaining an equalization-corrected signal by performing a high-frequency emphasizing and filtering process on the amplitude limit signal, said amplitude limiting process individually setting each of an upper limit and a lower limit of the amplitude limit value.

17. A computer readable recording medium recording thereon a computer program for reproduction control and for controlling a computer provided in an information reproducing apparatus comprising: an amplitude limiting device for obtaining an amplitude limit signal by limiting an amplitude level of a read signal read from a recording medium on the basis of a predetermined amplitude limit value; and a filtering device for obtaining an equalization-corrected signal by performing a high-frequency emphasizing and filtering process on the amplitude limit signal, said amplitude limiting device individually setting each of an upper limit and a lower limit of the amplitude limit value, said computer program making the computer function as at least one portion of said amplitude limiting device and said filtering device.
